(19) United States
(12) Patent Application Publication
(10) Pub. No.: US 2012/0030224 A1
(43) Pub. Date: Feb. 2, 2012

(54) ENABLING ACTIVE CONTENT IN MESSAGING USING AUTOMATIC DATA REPLACEMENT

(75) Inventors: Ram COHEN, Tel Aviv (IL); Aryeh MERGI, Bazra (IL)

(73) Assignee: ACTIVEPATH LTD., Petah-Tiqva (IL)

(21) Appl. No.: 13/193,120

(22) Filed: Jul. 28, 2011

Related U.S. Application Data
(63) Continuation-in-part of application No. 12/846,029, filed on Jul. 29, 2010.
(60) Provisional application No. 61/510,077, filed on Jul. 21, 2011.

(51) Int. Cl. G06F 21/24; G06F 17/30

(52) U.S. Cl. 707/758; 726/27; 707/E17.005

(57) ABSTRACT

Systems, methods, and/or computer program products for automatic pointer activation, acquiring data not included in an obtained dataset and/or for enabling the later acquiring of data not included in the dataset. In some examples, upon automatic activation of a pointer in the dataset, data associated with the pointer may be acquired. In some of these examples the acquired data may include data which requires prior authentication. Additionally or alternatively in some of these examples, the acquired data or a version thereof may include at least one instruction which would not necessarily have been acceptable to every security module in the channel. Additionally or alternatively, in some examples, a pointer may be a candidate for automatic activation if the referenced provider matches any provider listed as being associated with automatic activation.

### CROSS REFERENCE TO RELATED APPLICATIONS

This application is a continuation in part of U.S. application Ser. No. 12/846,829 filed on Jul. 29, 2010, and claims the benefit of U.S. provisional No. 61/510,077 filed Jul. 21, 2011, both of which are hereby incorporated by reference herein.

### TECHNICAL FIELD OF THE PRESENTLY DISCLOSED SUBJECT MATTER

The disclosure relates to pointers in obtained data.

### BACKGROUND OF THE PRESENTLY DISCLOSED SUBJECT MATTER

Data obtained via the Internet and/or any other communication channel and displayed to the receiving user may sometimes include pointers. The receiving user may click on a pointer, for example in order to retrieve data that was not initially displayed.

### SUMMARY

In one aspect, the disclosed subject matter provides a method of acquiring data which was not included in an obtained dataset, comprising: recognizing that a dataset which was obtained over a communication channel includes a pointer or a transformation thereof; activating automatically the pointer; and providing authentication information so as to acquire data associated with the pointer.

In another aspect, the disclosed subject matter provides a method of enabling the later acquiring of data which will not be included in a dataset, comprising: inserting in a dataset a pointer or a transformation thereof; wherein after the dataset is obtained via a communication channel, the pointer is automatically activated and authentication information is provided so as to acquire data associated with the pointer.

In another aspect, the disclosed subject matter provides a method of acquiring data which was not included in an obtained dataset, comprising: recognizing that a dataset which was obtained over a communication channel includes a pointer or a transformation thereof; and automatically activating the pointer so as to acquire data associated with the pointer; wherein the acquired data or a version thereof includes at least one instruction which, would not necessarily have been acceptable to every security module in the channel.

In another aspect, the disclosed subject matter provides a method of enabling the later acquiring of data not included in a dataset, comprising: inserting in a dataset a pointer or a transformation thereof; wherein after the dataset is obtained via a communication channel, the pointer is automatically activated so as to acquire data associated with the pointer which includes, or after further handling would include, at least one instruction which would not necessarily have been acceptable to every security module in the channel.

In another aspect, the disclosed subject matter provides a method of automatic pointer activation, comprising: recognizing that a dataset which was obtained over a communication channel includes a pointer or a transformation thereof; determining whether or not the pointer is a candidate for automatic activation, based on whether or not there is a match between a provider referenced by the pointer and any provider listed as being associated with automatic activation; and if there is a match, activating automatically the pointer.

In another aspect, the disclosed subject matter provides a system for acquiring data which was not included in an obtained dataset, comprising: a pointer recognizer operable to recognize that a dataset which was obtained over a communication channel includes a pointer or a transformation thereof; and an automatic handler operable to activate automatically the pointer, and to provide authentication information so as to acquire data associated with the pointer.

In another aspect, the disclosed subject matter provides a system for enabling the later acquiring of data not included in a dataset, comprising: a pointer inserter operable to insert in a dataset a pointer or a transformation thereof; wherein after the dataset is obtained via a communication channel, the pointer is activated automatically and authentication information is provided so as to acquire data associated with the pointer.

In another aspect, the disclosed subject matter provides a system for acquiring data which was not included in an obtained dataset, comprising: a pointer recognizer operable to recognize that a dataset which was obtained over a communication channel includes a pointer or a transformation thereof; and an automatic handler operable to automatically activate the pointer so as to acquire data associated with the pointer; wherein the acquired data or a version thereof includes at least one instruction which would not necessarily have been acceptable to every security module in the channel.

In another aspect, the disclosed subject matter provides a system for enabling the later acquiring of data not included in a dataset, comprising: a pointer inserter operable to insert in a dataset a pointer or a transformation thereof; wherein after the dataset is obtained via a communication channel, the pointer is automatically activated so as to acquire data associated with the pointer which includes, or after further handling would include, at least one instruction which would not necessarily have been acceptable to every security module in the channel.

In another aspect, the disclosed subject matter provides a system for automatic pointer activation, comprising: a pointer recognizer operable to recognize that a dataset which was obtained over a communication channel includes a pointer or a transformation thereof; a checker operable to determine whether or not the pointer is a candidate for automatic activation, based on whether or not there is a match between a provider referenced by the pointer and any provider listed as being associated with automatic activation; and an automatic handler operable, if there is a match, to activate automatically the pointer.

In another aspect, the disclosed subject matter provides a computer program product comprising a computer useable medium having computer readable program code embodied therein for acquiring data which was not included in an obtained dataset, the computer program product comprising: computer readable program code for causing the computer to recognize that a dataset which was obtained over a communication channel includes a pointer or a transformation thereof; computer readable program code for causing the computer to activate automatically the pointer; and computer readable program code for causing the computer to provide authentication information so as to acquire data associated with the pointer.

In another aspect, the disclosed subject matter provides a computer program product comprising a computer useable medium having computer readable program code embodied therein for enabling the later acquiring of data which will not be included in a dataset, the computer program product comprising: computer readable program code for causing the computer to insert in a dataset a pointer or a transformation thereof; wherein after the dataset is obtained via a communication channel, the pointer is automatically activated and authentication information is provided so as to acquire data associated with the pointer.

In another aspect, the disclosed subject matter provides a computer program product comprising a computer useable medium having computer readable program code embodied therein for acquiring data which was not included in an obtained dataset, the computer program product comprising: computer readable program code for causing the computer to recognize that a dataset which was obtained over a communication channel includes a pointer or a transformation thereof; and computer readable program code for causing the computer to automatically activate the pointer so as to acquire data associated with the pointer; wherein the acquired data or a version thereof includes at least one instruction which would not necessarily have been acceptable to every security module in the channel.

In another aspect, the disclosed subject matter provides a computer program product comprising a computer useable medium having computer readable program code embodied therein for enabling the later acquiring of data not included in a dataset, the computer program product comprising: computer readable program code for causing the computer to insert in a dataset a pointer or a transformation thereof; wherein after the dataset is obtained via a communication channel, the pointer is automatically activated so as to acquire data associated with the pointer which includes, or after further handling would include, at least one instruction which would not necessarily have been acceptable to every security module in the channel.

In another aspect, the disclosed subject matter provides a computer program product comprising a computer useable medium having computer readable program code embodied therein for automatic pointer activation, the computer program product comprising: computer readable program code for causing the computer to recognize that a dataset which was obtained over a communication channel includes a pointer or a transformation thereof; computer readable program code for causing the computer to determine whether or not the pointer is a candidate for automatic activation, based on whether or not there is a match between a provider referenced by the pointer and any provider listed as being associated with automatic activation; and computer readable program code for causing the computer, if there is a match, to activate automatically the pointer.

### BRIEF DESCRIPTION OF THE DRAWINGS

In order to understand the subject matter and to see how it may be carried out in practice, embodiments will now be described, by way of non-limiting example only, with reference to the accompanying drawings, in which:

FIG. 1 is a high level block diagram of a network, according to some embodiments of the presently disclosed subject matter;

FIG. 2 is a block diagram of a recipient system, according to some embodiments of the presently disclosed subject matter;

FIG. 3 (including FIG. 3A and FIG. 3B) is a flowchart of a method of automatic pointer activation and/or acquiring data which was not included in an obtained dataset, according to some embodiments of the presently disclosed subject matter;

FIG. 4 is a block diagram of a data preparation system, according to some embodiments of the presently disclosed subject matter;

FIG. 5 is a flowchart of a method of enabling the later acquiring of data not included in a dataset, according to some embodiments of the presently disclosed subject matter;

FIG. 6 is a block diagram of an acquired data source, according to some embodiments of the presently disclosed subject matter;

FIG. 7 is a flowchart of a method of enabling acquisition of data associated with a pointer, according to some embodiments of the presently disclosed subject matter;

FIG. 8 illustrates an example of a data group prior to insertion of a pointer by data preparation system, according to some embodiments of the presently disclosed subject matter;

FIG. 9 illustrates an example of a dataset which includes a pointer, according to some embodiments of the presently disclosed subject matter;

FIG. 10 illustrates another example of a data group prior to insertion of a pointer by data preparation system, according to some embodiments of the presently disclosed subject matter;

FIG. 11 illustrates another example of a dataset which includes a pointer, according to some embodiments of the presently disclosed subject matter; and

FIG. 12 illustrates another example of a pointer, according to some embodiments of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

Systems, methods, and/or computer program products for automatic pointer activation, acquiring data not included in an obtained dataset and/or for enabling the later acquiring of data not included in the dataset. In same examples, upon automatic activation of a pointer in the dataset, data associated with the pointer may be acquired. In some of these examples the acquired data may include data which requires prior authentication. Additionally or alternatively in some of these examples, the acquired data or a version thereof may include at least one instruction which would not necessarily have been acceptable to every security module in the channel. Additionally or alternatively, in some examples, a pointer may be a candidate for automatic activation if the referenced provider matches any provider listed as being associated with automatic activation.

In the following detailed description, numerous specific details are set forth in order to provide a thorough understanding of the subject matter. However, it will be understood by those skilled in the art that some embodiments of the subject matter may be practiced without these specific details. In other instances, well-known methods, procedures and components have not been described in detail so as not to obscure the subject matter.

As used herein, the phrase “for example,” “such as”, “for instance”, e.g., and variants thereof describe non-limiting embodiments of the subject matter.

As used herein, and unless explicitly stated otherwise, the term instruction refers to an instruction to be executed by the recipient system. The term instruction is used in its usual sense as a synonym of order, direction, command, etc.

As used herein, and unless explicitly stated otherwise, the term “memory” refers to any module for storing data for the short and/or long term, locally and/or remotely. Examples of memory include inter-alia: any type of disk including floppy disk, hard disk, optical disk, CD-ROMs, magnetic-optical disk, magnetic tape, flash memory, random access memory (RAMs), dynamic random access memory (DRAM), static random access memory (SRAM), read-only memory (ROMs), programmable read only memory (PROM), electrically programmable read-only memory (EPROMs), electrically erasable and programmable read only memory (EEPROMs), magnetic card, optical card, any other type of media suitable for storing electronic instructions and capable of being coupled to a system bus, a combination of any of the above, etc.

Reference in the specification to “one embodiment”, “an embodiment”, “some embodiments”, “another embodiment”, “other embodiments”, “some other embodiments”, “one instance”, “an instance”, “some instances”, “another instance”, “other instances”, “some other instances”, “one case”, “a case”, “some cases”, “another case”, “other cases”, “some other cases”, or variants thereof means that a particular feature, structure or characteristic described in connection with the embodiment(s) is included in at least one non-limiting embodiment of the presently disclosed subject matter. Thus the appearance of the phrase “one embodiment”, “an embodiment”, “some embodiments”, “another embodiment”, “other embodiments”, “some other embodiments, “one instance”, “an instance”, “some instances”, “another instance”, “some other instances”, “one case”, “a case”, “some cases”, “another case”, “other cases”, “some other cases”, or variants thereof does not necessarily refer to the same embodiment(s).

It should be appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Unless specifically stated otherwise, as apparent from the following discussions, it is appreciated that throughout the specification discussions utilizing terms such as “receiving”, “determining”, “recognizing”, “adding”, “prompting”, “activating”, “providing”, “obtaining”, “retrieving”, “storing”, “specifying”, “arranging”, “placing”, “replacing”, “executing”, “processing”, “validating”, “authenticating”, “adjusting”, “filtering”, “transforming”, “inserting”, “pointing”, “transferring”, “fetching”, “acquiring”, “triggering”, “causing”, “allowing”, “deriving”, “sending”, “using”, “transforming”, “inverse transforming”, “handling”, “removing”, “stripping”, “managing”, “presenting”, “transferring”, “preparing”, storing“, “comparing”, “substituting”, “embedding”, or the like, refer to the action and/or processes of any combination of software, hardware and/or firmware. For example, these terms may refer in some cases to the action and/or processes of a programmable machine, that manipulates and/or transforms data represented as physical, such as electronic quantities, within the programmable machine's registers and/or memories into other data similarly represented as physical quantities within the programmable machine's memories, registers or other such information storage, transmission or display elements.

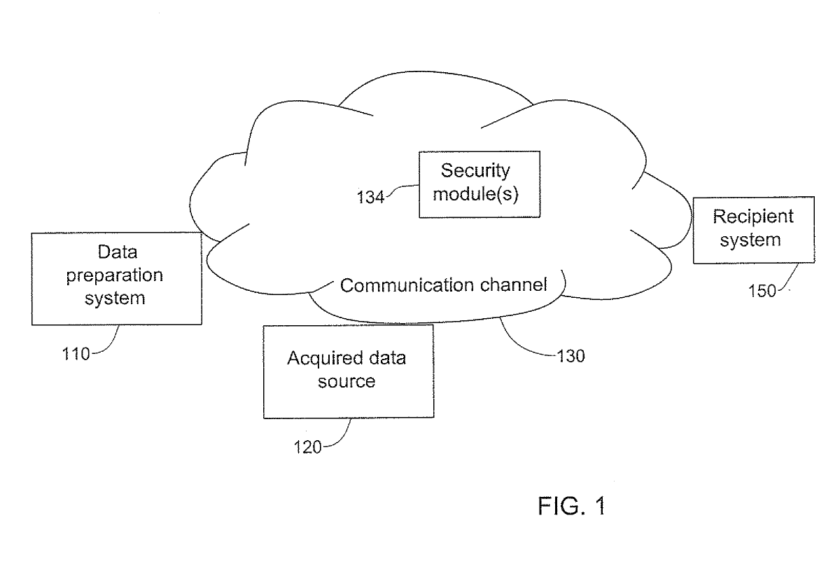

Referring now to the drawings, FIG. 1 illustrates a network 100 according to some embodiments of the presently disclosed subject matter. In the illustrated embodiments, network 100 includes one or more data preparation systems 110 configured to prepare data, one or more recipient systems 150 configured to receive data, one or more communication channels 130, and one or more acquired data sources 120 configured to be the source of acquired data. Each data preparation system 110, recipient system 150 and/or acquired data source 120 may be made up of any combination of hardware, software and/or firmware capable of performing the operations as defined and explained herein. For example, in some embodiments, any of data preparation system 110, recipient system 150 and/or acquired data source 120 may comprise a machine specially constructed for the desired purposes, and/or may comprise a programmable machine selectively activated or reconfigured by specially constructed program code. For simplicity of illustration and description, a single data preparation system 110, a single recipient system 150, a single acquired data source 120, and a single communication channel 130 are illustrated in FIG. 1 and described below, but usage of the single form for any one of these elements particular module of the above should be understood to include both embodiments where there is one of that element in network 100 and embodiments where there is a plurality of that element in network 100.

Depending on the embodiment, modules in data preparation system 110 may be concentrated in the same location, for example in one unit or in various units in proximity of one another, or modules of data preparation system 110 may be dispersed over various locations.

In some embodiments, some or all of data preparation system 110 may be located at the same location as the element which originates the data that is then prepared by data preparation system 110. For example, some or all of data preparation system 110 may be located at the same element which originates the data, with data preparation occurring as part of the data origination, or data preparation occurring after the data origination. As another example of these embodiments, some or all of data preparation system 110 may be located in proximity of the element which originates the data. The element which originates the data may be a user device or an element which services multiple user devices. Examples of user devices which may originate the data include personal computers, cell phones, laptops, smartphones, tablet computers, etc. Examples of elements which may originate data and service multiple user devices includes proxy servers, gateways, other types of servers, etc.

Additionally or alternatively, in some other embodiments, some or all of data preparation system 110 may be located at different location(s) than the element which originates the data that is then prepared by data preparation system 110. In these embodiments, the originated data may be transferred directly or indirectly to data preparation system 110 via channel 130 and/or via different communication channel(s). For example, when transferring to a different location, the data may in some cases be transferred in a manner which precludes filtering by any channel security module(s) for example using a cryptographic protocol such as Secure Socket Layer (SSL) or using communication channel(s) without channel security module(s). Continuing with the example, in some embodiments where the location of some or all of data preparation system 110 is not dictated by the location of the element which originated the data, some or all of data preparation system 110 may reside anywhere in network 100, for example on a gateway, proxy server, other type of server, on any other element servicing multiple user devices, etc.

Depending on the embodiment, modules in acquired data source 120 may be concentrated in the same location, for example in one unit or in various units in proximity of one another, or modules of acquired data source 120 may be dispersed over various locations.

For simplicity of illustration, acquired data source 120 is shown separate from data preparation system 110, with communication between acquired data source 120 and data preparation system 110 and between acquired data source 120 and recipient system 150 shown as being via communication channel 130. However, depending on the embodiment, some or all of acquired data source 120 may be located in the same unit as preparation system 110 and/or some or all of acquired data source 120 may be separate from preparation system 110. In embodiments where separate, the data transfer between data preparation system 110 and the separated some or all of acquired data source 120 may be via communication channel 130 and/or via different communication channel(s). In some cases data may be transferred between data preparation system 110 and acquired data source 120 and/or between acquired data source 120 and recipient system 150 in a manner which precludes filtering by any channel security module(s) for example using a cryptographic protocol such as SSL or using communication channel(s) without channel security module(s).

In embodiments where the location of some or all of acquired data source 120 is not dictated by the location of data preparation system 110, some or all of acquired data source 120 may reside anywhere in network 100, for example, on a gateway, proxy server, other type of server, any other element servicing multiple user devices, etc.

Depending on the embodiment, modules in recipient system 150 may be concentrated in the same location, for example in one unit or in various units in proximity of one another, or modules of recipient system 150 may be dispersed over various locations.

The disclosure does not limit the type of recipient system 150. For example, in various embodiments some or all of recipient system 150 may be included in a user device such as a personal computer, cell phone, smartphone, laptop, tablet computer, etc., may be included in element(s) which service multiple user devices such as proxy server(s), gateway(s), other types of servers, etc, and/or may be included in a combination of the above.

In some embodiments, a particular location or locations may include a recipient system such as system 150 and also (integrated or not integrated with the recipient system) a data preparation system such as system 110, an element which originates data and/or an acquired data source such as source 120. In these embodiments, the functionality of the particular location(s) may in some cases vary, for example for different data. In some embodiments, additionally or alternatively, a specific location or locations may include only a recipient system such as system 150 or may include only a data preparation system such as system 110, an element which originates data and/or an acquired data source such as 120. In these embodiments, the functionality of the specific location(s) may in some cases be consistent,

In various embodiments, communication channel 130 may comprise any suitable infrastructure for network 100 that provides direct or indirect connectivity at least between data preparation system 110 and recipient system 150. Communication channel 130 may use for example one or more wired and/or wireless technology/ies. Examples of channel 130 include cellular network channel, personal area network channel, local area network channel, wide area network channel, internetwork channel, Internet channel, any combination of the above, etc. In the illustrated embodiments, communication channel 130 includes security module(s) 134 such as firewalls, anti-spam software, security policies, anti-virus programs, any combination of the above, etc. in order to protect recipient system 150 from potentially dangerous data. However in other embodiments, security module(s) 134 may be absent. In embodiments which also include other communication channel(s) in network 100, the other communication channel(s) may comprise any suitable infrastructure for network 100, and may use one or more wired and/or wireless technologies.

In some embodiments with security module(s) 134, it is assumed that when a security module filters data, the security module allows data which is in an acceptable form to pass unhindered, whereas embodiments of the presently disclosed subject matter do not constrain the manner in which a security module handles data which includes an unacceptable instruction. For example, in various embodiments, the unacceptable instruction may be removed, all the data may be deleted, the data may be classified as containing a potentially dangerous instruction, etc. lit is noted that in some of these embodiments, a form which is acceptable to one security module may be unacceptable to another security module, and/or an instruction which is unacceptable to one security module may be acceptable to another security module.

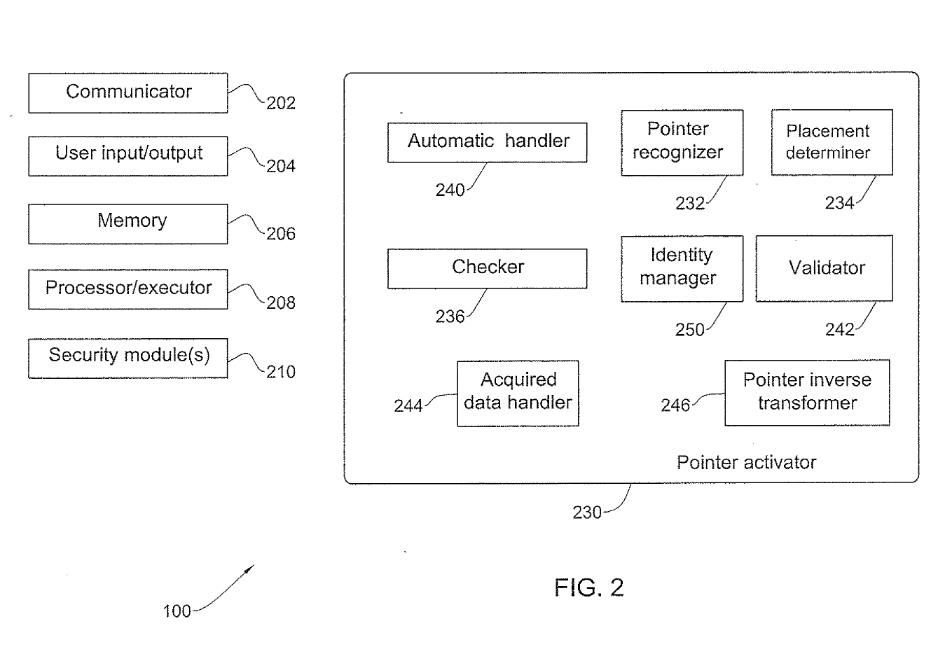

FIG. 2 is a block diagram of recipient system 150, according to some embodiments of the presently disclosed subject matter. In the illustrated embodiments, recipient system 150 includes a communicator 202 configured to communicate via channel 130 and/or via another channel in network 100, a user input/output 204 configured to receive data from a (receiving) user of recipient system 150 and/or present data to a (receiving) user of recipient system 150, and a pointer activator 230 configured to activate pointers as described herein. Examples of user input/output 204 include keyboard, mouse, keypad, touch-screen display, microphone, speaker, non-touch-screen display, and/or printer, etc.

In some embodiments, recipient system 150 may optionally also include a memory 206 configured to store data, a processor/executor 208 configured to process data including executing instructions (if any) during processing, and security module(s) 210 configured to protect recipient system 150 from potentially dangerous data. Examples of security module(s) 210 include: firewalls, anti-spam software, security policies, antivirus programs, any combination of the above, etc.

In the illustrated embodiments, pointer activator 230 includes a pointer recognizer 232 configured to recognize that an obtained dataset includes pointer(s) which are potentially candidate(s) for automatic activation, or transformation(s) thereof, and an automatic handler 240 configured to handle automatic activation of pointers. For example automatic activation may refer to activation which is performed without user involvement in the activation. Pointer activator 230 may optionally also include any of the following modules: a placement determiner 234 configured to determine and/or arrange placement of data acquired due to pointer activation or of a version thereof, a checker 236 configured to determine whether or not recognized pointers should be activated, a validator 242 configured to validate, an acquired data handler 244 configured to handle data acquired due to pointer activation, a pointer inverse transformer 246 configured to inverse transform transformations of pointers, and/or an identity manager 250 configured to manage authentication information.

In some embodiments where data is acquired as a result of pointer activation, pointer activator 230 may function as a system configured to acquire data which was not included in an obtained dataset.

In the illustrated embodiments, recipient system 150 includes at least some hardware and in various embodiments, each of communicator 202, user input/output 204, memory 206, processor/executor 208, pointer activator 230, security module(s) 210 pointer recognizer 232, placement determiner 234, checker 236, automatic handler 240, validator 242, acquired data handler 244, pointer inverse transformer 246, and/or identity manager 250 may be made up of any combination of hardware, software and/or firmware capable of performing the operations as defined and explained herein. In some embodiments, any of the modules in recipient system 150 may be included in any of the following: a web browser; a mail client; an instant messaging client; a peer to peer application; a user interface; an SMS application; a messaging application; any other type of Internet client; a plug-in, an add-on, a toolbar, or an applet for a browser, mail client, instant messaging client, or any other application; a standalone client; any other suitable element servicing one user device; a gateway; a proxy server; any other type of server; and/or any other suitable element servicing multiple user devices; an element with any other suitable configuration; etc.

In some embodiments, recipient system 150 may comprise fewer, more, and/or different modules than those shown in FIG. 2. Additionally or alternatively, in some embodiments, the functionality of recipient system 150 described herein may be divided differently among the modules of FIG. 2. For example, in some cases acquired data handler 244 and pointer inverse transformer 246 may share a common inverse transformation engine. Additionally or alternatively in some embodiments, the functionality of recipient system 150 described herein may be divided into fewer, more and/or different modules than shown in FIG. 2 and/or recipient system 150 may include additional, less and/or different functionality than described herein. For example, pointer activator 230 may in some cases comprise fewer, more and/or different modules for activating pointers, the functionality for activating pointers may be divided differently among the illustrated modules, and/or pointer activator 230 may include additional, less and/or different functionality than described herein. As another example, additionally or alternatively, one or more modules in FIG. 2 which are illustrated as being external to pointer activator 230 may in some cases be inside pointer activator 230, or similar module(s) may be included inside pointer activator 230. For instance, in some of these cases memory, communicator and/or security module(s) may be included in pointer activator 230. As another example, additionally or alternatively, one or more modules in FIG. 2 which are illustrated as being internal to pointer activator 230 may in some cases be included outside pointer activator system 230, or similar module(s) may be included outside pointer activator 230. For instance in some of these cases, validator and/or acquired data handler module(s) may be included outside pointer activator 230. As another example, additionally or alternatively the functionality of processor/executor 208 and acquired data handler 244 may be combined in one module.

Depending on the embodiment modules in recipient system 150 may be concentrated in one unit or separated among two or more units. For example, recipient system 150 may include an embedded display or a detached display when input/output 204 includes a display. As another example, additionally or alternatively, recipient system 150 may be divided into two subsystems, which may or may not be located at the same location. As another example, additionally or alternatively, in some cases modules in recipient system 150 may be divided between a plurality of elements, with certain element(s) in the plurality selected from any of the following: a web browser, a mail client, an instant messaging client, a peer to peer application, a user interface, a messaging application, an SMS application, any other type of Internet client, any other suitable element servicing one user device, a gateway, a proxy server, any other type of server, any other suitable element servicing multiple user devices, and/or an element with any other suitable configuration; and with other element(s) in the plurality selected from any of the following: an applet, toolbar, plug-in or add on to a certain element, a standalone element associated with one user device, a gateway, a proxy server, any other type of server, any other standalone element servicing multiple user devices, and/or a standalone element with any other suitable configuration. In these embodiments, the various elements may or may not be located at the same location.

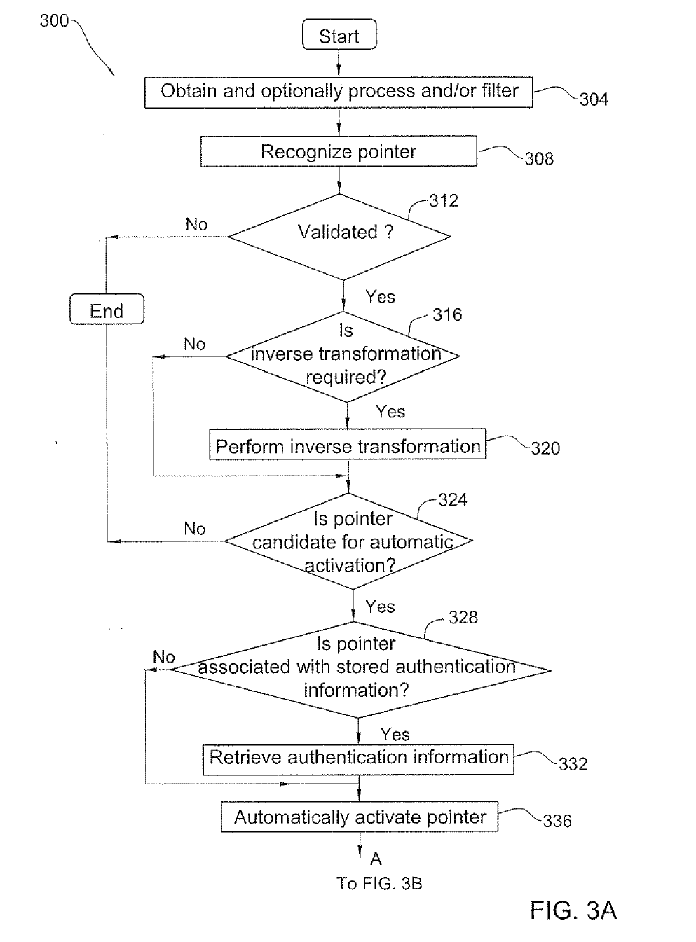

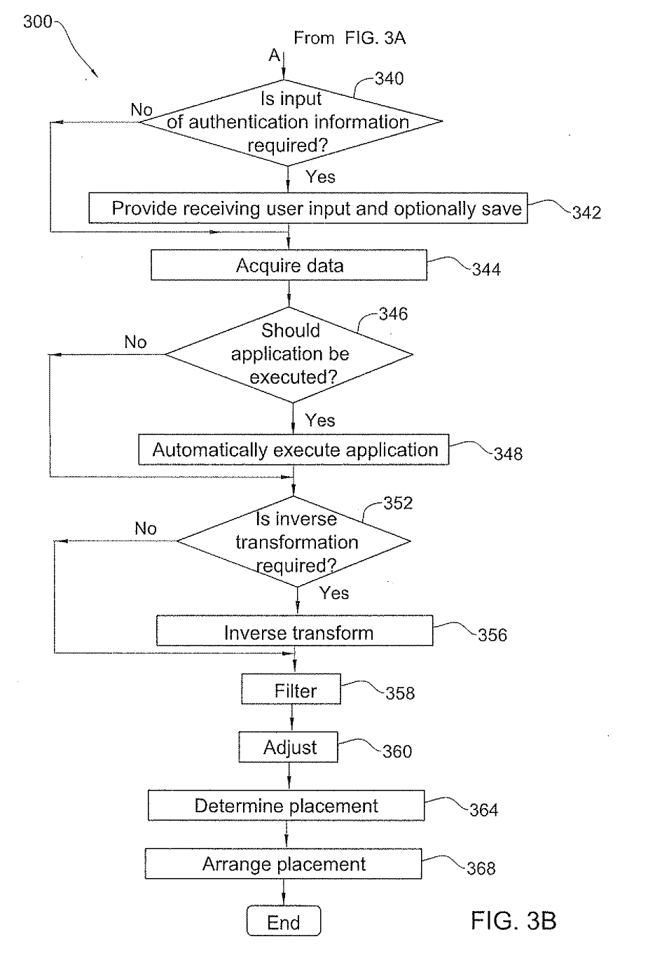

FIG. 3 is a flowchart of a method 300 of automatic pointer activation and/or acquiring data which was not included in an obtained dataset, according to some embodiments of the presently disclosed subject matter. Method 300 may be performed in some embodiments by recipient system 150. In some cases, method 300 may include fewer, more and/or different stages than illustrated in FIG. 3, the stages may be executed in a different order than shown in FIG. 3, stages that are illustrated as being executed sequentially may be executed in parallel, and/or stages that are illustrated as being executed in parallel may be executed sequentially.

In the illustrated embodiments, in stage 304 a set of data (“dataset”) is obtained via channel 130 for example by communicator 202. For example, the obtained dataset may have been sent (e.g. by data preparation system 110), or may have been pulled (e.g. from data preparation system 110), depending on the embodiment. For simplicity of description, it is assumed that the obtained dataset includes at most one pointer which may be a potential candidate for automatic activation, or a transformation thereof. For example, the pointer or transformation may have been inserted in the dataset earlier by data preparation system 110. However similar methods and systems to those described herein may be used if the dataset includes multiple pointers and/or transformations which are potential candidates for automatic activation, mutatis mutandis. The disclosure does not impose limitations on handling multiple pointers and/or transformations. For instance, in some cases, all but one pointer or pointer transformation may be ignored. In another instance, two or more of the pointers and/or transformations may be considered, each of which may be provided with its own area in the display or with its own separate window. In this instance, for example, the pointers and/or transformations to be considered may be selected automatically or the receiving user may be prompted to select the pointers to be considered.

In some embodiments, the dataset (which includes the pointer or transformation thereof) may have been transferred via channel 130 in a form acceptable to most (AKA a majority of) channel security module(s) 134 and/or to security module(s) 210, or alternatively in a form acceptable to substantially all channel security module(s) 134 and/or to security module(s) 210. For instance in some of these embodiments, the pointer or transformation which is included in the dataset may include only plain text (e.g. no hypertext markup language HTML tags) or may not include certain HTML tags such as script tags. In some embodiments, additionally or alternatively, the dataset (including the pointer or transformation thereof) may be in a form supported by most available receiving systems which could potentially be used to receive the data, or alternatively supported by substantially all available receiving systems which could potentially be used to receive the data.

The disclosure does not impose limitations on the pointer which is included or whose transformation is included in the dataset. For example, in some embodiments, the pointer may be associated with a resource (e.g. data to be acquired and/or other resource) and may specify the location where the resource is available. Optionally in these embodiments the pointer may also specify the resource, the means to retrieve the resource, the method to retrieve the resource, and/or parameter(s) to retrieve the resource (such as resource ID). Continuing with the example, in some cases the pointer may specify a uniform resource locator “URL” (e.g. address of webpage) or other location indication and may also include parameters regarding the communication method or protocol to be used to retrieve the data. In some embodiments, the pointer may additionally or alternatively specify the name and/or location of a stored application, for instance locally stored in memory 206 or elsewhere in the recipient system, which is to be executed. In some embodiments, the pointer may additionally or alternatively specify a generic reference. In some embodiments, the pointer may additionally or alternatively be what is termed a personal pointer in that the pointer may include an identification parameter. For instance the personal pointer may be a personal URL (“purl”). In some embodiments, the pointer may additionally or alternatively specify if the pointer is to be automatically activated. In some embodiments, the pointer may additionally or alternatively specify validation requirement(s) and/or validation item(s) In some embodiments, the pointer may additionally or alternatively specify other parameter(s) relevant and/or irrelevant to the currently disclosed subject matter.

Depending on the embodiment, upon receipt by recipient system 150 the dataset including at least the pointer or transformation may or may not be filtered, for example by security module(s) 210.

Depending on the embodiment, the set of data including the pointer or transformation may or may not be initially processed for presentation (before continuing with the remaining stages of method 300), for example by processor/executor 208. It is assumed that in embodiments with initial processing for presentation at this stage, any initial processing does not lead to pointer activation.

In some embodiments with initial processing, the processing for presentation may include parsing the dataset into a document object model or similar model stored for example in memory 206.

In embodiments with initial processing, after processing for presentation, the dataset may or may not be presented to the receiving user via user input/output 204, depending on the embodiment. For example, in some of these embodiments, data which has been processed for presentation may be routinely presented. As another example, in some of these embodiments, the pointer or transformation may not be presented but other data in the set, if any, may be presented. As another example, in some of these embodiments at least the pointer or transformation may be presented if desirable for later validation in stage 312. As another example, in some of these embodiments the dataset may not be presented at this stage.

In the illustrated embodiments in stage 308, recipient system 150, for instance pointer recognizer 232 recognizes that the dataset includes a pointer which is a potential candidate for automatic activation, or a transformation thereof For example, in some embodiments with initial processing, pointer recognizer 232 may examine the document object model or similar model, to which processor/executor 208 parsed the dataset. As another example, in some embodiments without initial processing, pointer recognizer 232 may examine the obtained dataset.

Pointer recognizer 232 may recognize in the dataset a pointer which is potentially a candidate to be automatically activated, or a transformation thereof, in various ways depending on the embodiment. For example in some embodiments, the pointer or transformation may be accompanied by one or more tag(s) so as to be recognized, for instance a beginning and/or end tag(s). The type of tagging is not limited by embodiments of the presently disclosed subject matter and may be any suitable tagging. As another example, in some embodiments pointer recognizer 232 may additionally or alternatively recognize a pointer as potentially being a candidate for activation by the format/contents of the pointer. As another example, in some embodiments, notification data in the dataset and/or a separate indication may additionally or alternatively indicate whether or not such pointer(s) are included. As another example, in some embodiments, it may additionally or alternatively be known a-priori that the pointer or transformation comprises the entire dataset or a predetermined part of the dataset.

In the illustrated embodiments, in stage 312, recipient system 150, for instance validator 242, determines whether or not to validate the dataset and/or pointer (or transformation thereof). For example validation requirement(s) may include validator 242 performing any of the following on validation associated item(s): checking the internal integrity of the dataset and/or pointer (or transformation thereof), checking a message authentication code of the dataset and/or pointer (or transformation thereof), checking a hash of the dataset and/or pointer (or transformation thereof), checking a digital signature of the dataset and/or pointer (or transformation thereof), checking the certificate with which the dataset and/or pointer (or transformation thereof) was signed, checking for a specific location (e.g. uniform resource locator URL) and accessing information at a remote location via the URL in order to perform validation, and/or any other validation procedure.

In some cases, validation requirement(s) and/or validation item(s) may be specified in the pointer, in the transformation, or elsewhere in the dataset, and/or may be known to validator 242 without being included in the dataset, for example based on predetermined practice, retrieval from memory 206 and/or on-the-fly generation. In some embodiments, stages 312 may instead take place before stage 308. In some of these embodiments, validation may take place independently of pointer recognition.

In the illustrated embodiments with stage 312, if validation failed (no to stage 312), then method 300 ends. Otherwise, if the performed validation succeeded (yes to stage 312), then method 300 continues with stage 316.

In some other embodiments, validation may not take place and therefore stage 312 may be omitted. In these embodiments there would be no requirement for validation to have succeeded in order for method 300 to continue to stage 316.

In the illustrated embodiments, in stage 316, it is determined by recipient system 150, for instance by pointer recognizes 232 if a pointer transformation is included in the dataset (e.g. the pointer was transformed by data preparation system 110 and the transformation of the pointer was inserted in the dataset) and therefore inverse transformation of the pointer transformation is required. For example, in some implementations, inverse transformation may always be required or may never be required. In another example, the beginning and/or end tag, format/contents of the pointer/transformation, separate indication, and/or notification data in the dataset, may indicate whether or not inverse transformation should be performed and/or the type of inverse transformation.

If inverse transformation is required (yes to stage 316) then in the illustrated embodiments, in stage 320, recipient system 150, for instance pointer inverse transformer 246, inverse transforms the pointer transformation, in accordance with an inverse transformation which is typically the inverse of a transformation performed on the pointer (e.g. by data preparation system 110). If inverse transformation is not required, then in the illustrated embodiments, stage 320 is omitted.

In some embodiments, the dataset may include a pointer transformation and therefore inverse transformation may be required prior to performing subsequent stages of method 300, whereas in some other embodiments the dataset may include a pointer and not a pointer transformation and therefore inverse transformation may not be required prior to performing subsequent stages of method 300. For instance, in some embodiments a transformation of the pointer rather than the pointer is included in the dataset, if the pointer would have included hypertext markup language HTML tags or certain HTML tags such as script tags which would not necessarily have been acceptable to elements such as channel security module(s) 134, and/or recipient security module(s) 210. Additionally or alternatively, in some embodiments where a pointer per-se may not necessarily be acceptable to elements such as every channel security module 134, and/or recipient security module 210, the format/contents of any pointer included in the dataset may be recognizable to pointer recognizes 232 as a pointer but not necessarily recognizable to other elements such as channel security module(s) 134, and/or recipient security module(s) 210 as a pointer. In some of these embodiments, the pointer may therefore not have been transformed (e.g. by data preparation system 110) and inverse transformed by inverse transformer 248. However in some other of these embodiments the pointer may in any event have been transformed (and inverse transformed).

The disclosure does not impose limitations on the type of inverse transformation performed in stage 320. The inverse transformation may be any suitable inverse transformation which typically is the inverse of the previously performed transformation (e.g. by data preparation system 110). In some embodiments, the inverse transformation includes at least one of decrypting, decoding, decompressing, etc. Additionally or alternatively, in some embodiments, the inverse transformation may recover the pointer in a form would not necessarily have been acceptable to every channel security module(s) 134, and/or security module(s) 210 and/or may recover the pointer in a form which would not necessarily have been supported by every available receiving system which could potentially have obtained the pointer (for example not necessarily supported by receiving systems without pointer activator 230).

In some other embodiments, any inverse transformation of a pointer transformation may occur prior to stage 308 and/or stage 312 rather than as illustrated in FIG. 3. In some of these embodiments recipient system 150 may perform inverse transformation of part or all of the obtained dataset, independently of pointer recognition. Additionally or alternatively, in some of these embodiments inverse transformation of the pointer transformation may be required or preferable prior to performing validation (stage 312), for instance if specified validation requirement(s) and/or validation item(s) are only comprehensible after inverse transformation.

In some other embodiments, the obtained dataset may never include a pointer transformation and therefore stages 316 and 320 may be omitted.

In the illustrated embodiments in stage 324, recipient system 150, for instance checker 236, checks whether or not the pointer is a candidate for automatic activation. In some embodiments, it may be determined that the pointer is a candidate for automatic activation based on a specification in the pointer and/or in the dataset, and/or it may be determined that the pointer is a candidate for automatic activation based on a characteristic of the pointer and/or of the dataset. For example, automatic activation may be specified in the pointer, in the tags, and/or in notification data in the dataset.

In embodiments where it is determined that the pointer is a candidate for automatic activation based on a characteristic, the disclosure does not impose limitations on the characteristic.

In some of these embodiments, the characteristic may refer to the origin. For instance, in some cases pointers in datasets prepared by certain data preparation systems and/or corresponding to datagroups originating from certain elements may be automatically activated whereas pointers in datasets prepared by other data preparation systems and/or corresponding to datagroups originating from other elements may not be automatically activated.

In some of these embodiments, the characteristic may additionally or alternatively refer to part or all of the pointer contents/format.

For example, in some instances of these embodiments if the pointer contents/format include certain element(s) such as an identification parameter (relating to personal pointer), and/or name and/or location of an application, then it may be determined in some cases that the pointer is a candidate for automatic activation. In other instances, the inclusion of an identification parameter and/or name and/or location of an application may not necessarily mean that the pointer is a candidate for automatic activation.

Additionally or alternatively, as another example, in some instances, there may be a list published on the Internet or a list stored for example in memory 206. In some of these instances, the list may relate to pointer activation being desired or not being desired. In some cases of this example, entries in the list may be automatically generated, for instance based on known safe or unsafe activities. In other cases, entries in the list may additionally or alternatively be semi-automatically generated based on pointers which the receiving user had previously manually activated or not activated, and/or based on whether or not the receiving user has expressed that automatic activation is or is not desirable. In other cases, additionally or alternatively, entries in the list may be manually inputted and/or changed by a receiving user. In this example, if some or all of the pointer contents/format matches an entry on the list, then the pointer may or may not be a candidate for automatic activation depending on the nature of the list.

Continuing with this example and assuming that the characteristic relates at least to a referenced provider included in the pointer contents/format, in some of these instances, the list may include (at least) a list of providers (e.g. names, servers and/or corresponding domains) which may be referenced by pointers. Depending on the instance, the list may list all known providers and/or may list whether or not automatic activation is desired for a provider. In some cases, the first time a pointer, say “content.acme.com” is detected which references a provider (e.g. “acme”) not on the list, the receiving user may be prompted for manual activation (e.g. to allow pointer follow up once, always, or not allow). Alternatively, checker 235 may ignore the pointer because the provider is not on the list. In some of these cases, if the receiving user expressed the desire to always allow the pointer to be followed up then the provider referenced by the pointer (e.g. name, and/or corresponding server(s)/domain(s)) may be added to the list so that the next time a pointer references the provider, the pointer may be a candidate for automatic activation. Alternatively, the provider may be added to the list as a known provider, but not necessarily as a candidate for automatic activation. For instance, if the provider is acme, then in some cases all possible domains may be added to the list such as “content.acme.com”, “*.acme.com”, etc. In some cases, if the pointer references a provider which matches a provider on the list, the pointer may be a candidate for automatic activation. Alternatively, even if there is a match, the pointer may not be a candidate for automatic activation and the user may be prompted for manual activation (e.g. to allow pointer follow up once, always, or not allow). For instance, if the list included all known providers and not necessarily only those corresponding to automatic activation, the pointer may not necessarily be a candidate for automatic activation even if there is a match.

In some other embodiments, it may be determined that the pointer is a candidate for automatic activation based on a separate indication, or it may be known a-priori that the pointer is or is not a candidate for automatic activation.

In some cases, it may be advantageous that automatic activation is not necessarily dictated for every pointer, allowing more flexibility in dealing with pointers.

If the pointer is not a candidate for automatic activation (no to stage 324), then in the illustrated embodiments method 300 ends without automatic pointer activation. For instance, in some of these embodiments where the pointer is not a candidate for automatic activation, the activation of the pointer may require the involvement of the receiving user, and therefore the pointer may or may not be manually activated by the receiving user in a conventional manner.

In some other embodiments, stage 324 may be omitted, for instance because all pointers are candidates for automatic activation and therefore there is no need for checking.

In the illustrated embodiments, in stage 328, it is determined by recipient system 150, for instance by identity manager 250, if the pointer or part of the pointer is associated with stored authentication information which is required in order to complete the activity which begins with automatic pointer activation (for instance in order to acquire data from acquired data source 120). For instance, in some cases, identity manager 250 may search in memory 206 for a stored correspondence between the pointer, or part of the pointer (e.g. specified webpage address), and authentication information. Continuing with this instance, in some of these cases, the correspondence may have been stored the first time that (a copy of) the pointer or of part of the pointer (e.g. a pointer specifying the same address) was activated. Depending on the embodiment, the authentication information may be associated with a single potential receiving user or with multiple potential receiving users.

In some embodiments, before searching in memory, recipient system 150, for instance pointer recognizes 232, may determine whether or not the pointer includes an identification parameter, and only if the pointer includes an identification parameter, search of memory 206 for authentication information would be performed.

If the pointer or part of the pointer is associated with stored authentication information (yes to stage 328), then in the illustrated embodiments in stage 332 the authentication information is retrieved from memory 206 by recipient system 150, for example by identity manager 250.

If the pointer is not associated with stored authentication information (no to stage 328), then in the illustrated embodiments stage 332 is omitted. For instance, in some embodiments the pointer may be a “public” pointer (without an identification parameter) and therefore the concept of associated authentication information would be irrelevant, or the pointer may include an identification parameter but there may not be any stored associated authentication information.

In some other embodiments, there is no storage of authentication information for pointers and therefore stages 328 and 332 may be omitted.

The disclosure does not impose limitations on authentication information. In some embodiments, authentication information is information which allows authentication of the receiving user and/or recipient system. For example, authentication information may include user name, password, decryption key, user credentials, hardware token, etc.

In the illustrated embodiments in stage 336 the pointer is automatically activated by recipient system 150, for instance by automatic handler 240. In some embodiments, by automatically activating the pointer, automatic handler 240 requests data associated with the pointer from acquired data source 120 where the data is available. In some other embodiments, automatic activation of the pointer may not necessarily include a request for data.

In some cases, it may be advantageous to automatically activate the pointer because the receiving user may not realize how to manually activate the pointer, and/or because the receiving user may prefer not to have to manually activate the pointer.

In some embodiments, recipient system 150, for instance automatic handler 240, may be configured to automatically provide retrieved authentication information, if any, during the automatic activation. For example automatic provision of the authentication information may refer to provision which is performed without user involvement. In some of these embodiments, any associated retrieved authentication information may be automatically provided when automatically activating a pointer which is a personal pointer in that the pointer includes an identification parameter. For instance the personal pointer may be a personal URL. In some cases, the retrieved authentication information may be sent to acquired data source 120 where (private) data associated with the pointer is available. Private data may be considered to be any data which is only available to a single potential receiving user or to multiple potential receiving users after authentication. Additionally or alternatively, in other cases the retrieved authentication information may be sent elsewhere (e.g. data preparation system 110, element originating data, etc). For instance, in some cases upon activation of a pointer in a verification message (e.g. sent to verify the establishing of an account or service) and provision of retrieved authentication information, data may not necessarily be acquired. Continuing with this instance in some of these cases when a pointer in a verification message is activated no data is acquired whereas in some other of these cases, data is acquired (e.g. confirmation of account or service establishment, etc).

In some embodiments where retrieved authentication information is automatically provided during pointer activation, the authentication information may be automatically provided when initially contacting acquired data source 120 or elsewhere (e.g. data preparation system 110, element which originated the data which is then prepared by data preparation system 110, etc), and/or after the initial contact. In some of these embodiments, if the authentication information is provided during the initial contact to acquired data source 120 or elsewhere, acquired data source 120 or elsewhere may accept the pointer activation, without further authentication. For instance, acquired data source 120 may permit acquirement of private data associated with the pointer without further authentication. Additionally or alternatively in some other embodiments retrieved authentication information may be automatically provided after the initial contact, for example after receiving a request for the authentication information from acquired data source 120 or elsewhere. In some cases of these latter embodiments, recipient system, for example automatic handler 240, may recognize the request for authentication information by the fields which need to be filled in such as username and/or password, etc.

In some cases, automatic provision of the authentication information may be advantageous to the receiving user, for instance because the receiving user may not know how to be involved in the provision, such as not knowing how to input the authentication information. Additionally or alternatively, for instance, the receiving user may prefer not be involved in the provision such as preferring not to have to input the authentication information.

In the illustrated embodiments in stage 340, it is determined if input by the receiving user of authentication information is necessary. For example, receiving user input of authentication information may be necessary if authentication information is requested by acquired data source 120 or elsewhere (e.g. data preparation system 110, element which originated the data which is then prepared by data preparation system 110, etc) after activation of the pointer but the requested authentication information is not stored in memory 206 and therefore can not be automatically provided. The requested authentication information may not be stored in memory 206 for any reason. For example the requested authentication information may not be stored because this is the first time that (a copy of) the pointer or of part of the pointer (e.g. a pointer specifying the same address) is being activated. As another example, additionally or alternatively, the requested authentication information may not be stored because in this example no authentication information is stored for pointer activation. In this example, if authentication information is required, receiving user input of the authentication information is always necessary. As another example, additionally or alternatively, retrieved authentication information which was automatically provided during pointer activation may have not been sufficient, for instance because of increased authentication requirement(s) beyond the stored authentication information and/or because of a failure in retrieving and automatic provision. In this example, receiving user input of the requested authentication information may therefore be required.

If receiving user input of authentication information is not necessary (no to stage 340) then in the illustrated embodiments stage 342 is omitted. For instance, receiving user input of authentication information may not be necessary because all required authentication information was retrieved and automatically provided during pointer activation. Additionally or alternatively, for instance, receiving user input of authentication information may not be required, for example because the pointer may be a “public” pointer (without an identification parameter) and therefore the concept of inputting authentication information would be irrelevant. Additionally or alternatively, for instance receiving user input of authentication information may not be required even though the pointer has an identification parameter if authentication information is not requested by acquired data source 120 or elsewhere (e.g. data preparation system 110, element which originated the data which is then prepared by data preparation system 110, etc).

If receiving user input of requested authentication information is necessary (yes to stage 340), then in the illustrated embodiments in stage 342 receiving user input is received by recipient system, for instance by identity manager 250 via user input/output 204. For example, the request for additional authentication information may be presented to the receiving user who will then input the requested information. In the illustrated embodiments, the authentication information is then provided by recipient system 150, for instance by automatic handler 240. For example, the inputted authentication information may be provided to acquired data source 120 where data associated with the pointer is available, or to elsewhere (e.g. data preparation system 110, element which originated the data which is then prepared by data preparation system 110, etc).

In some examples of these embodiments, a correspondence between the pointer or part of the pointer (e.g. specified webpage address) and the inputted authentication may be stored in memory 206, for instance by identity manager 250.

In some other embodiments, receiving user input of authentication information may never be required during pointer activation and therefore stages 340 and 342 may be omitted.

In the illustrated embodiments in stage 344, recipient system 150, for instance automatic handler 240 acquires data from acquired data source 120. In some embodiments the acquired data may be transferred using the hypertext transfer protocol HTTP. In some embodiments, additionally or alternatively, the acquired data may be transferred in a way which precludes filtering by channel security module(s) 134, for instance using a cryptographic protocol such as SSL or for instance using a communication channel other than channel 130 which does not include channel security module(s). In some of these embodiments, the acquired data may include at least one instruction that would not necessarily have been acceptable to every channel security module 134, and/or to security module(s) 210 if the instruction(s) had been transferred as part of the dataset. Additionally or alternatively, in some embodiments, the acquired data may additionally or alternatively include private data and these embodiments assume that the provided authentication information allowed the data to be acquired.

The acquiring of the acquired data in stage 344 rather than as part of the obtained dataset may or may not be advantageous, depending on the embodiment. Possible advantages in some of embodiments include any of the following reasons inter-alia. First, as mentioned elsewhere in the description, in some cases the acquired data or a version thereof may include an instruction which would not necessarily have been acceptable to every possible security module(s) and/or may include data which would not necessarily have been supported by every available potential receiving system. Second, the acquired data may in some cases include private data for which authentication information is required to be provided. Third, a dataset with a pointer and transformation may in some cases be transferred more quickly and with less bandwidth than if the associated acquired data had instead been included. Fourth, data may be updated in between the times that the dataset is obtained and stage 344 so that the acquired data is more updated than if had been included in the obtained dataset.

In some embodiments, pointer activation may require communicating with a single acquired data source, whereas in other embodiments pointer activation may require communication with more than a single acquired data source. In an example of the latter embodiments, recipient system 150 may contact one acquired data source 120 to acquire data and subsequently or in parallel contact another acquired data source 120 to acquire some other data. One possible use for contacting more than a single acquired data source is if the activated pointer includes a reference to data stored on a first acquired data source and once that data is acquired it is necessary to contact a second acquired data source, communicate to the second acquired data source the data acquired from the first acquired data source and obtain from the second acquired data source the data to be used in steps 346 through 368. The first acquired data source may be used for example for any of monitoring, logging, billing, analysis operations while the second acquired data source may be the actual acquired data source from which the intended acquired data is obtained.

In some other embodiments, pointer activation does not lead to acquirement of data and therefore stage 344 may be omitted and/or method 300 may end at this stage. For example, in some cases of these embodiments, automatic activation of a pointer and provision of authentication information (e.g. retrieved and/or inputted) may not result in the acquiring of private data, for instance either because the provided authentication information is not correct or because the automatic activation of that particular pointer is not supposed to result in the acquiring of data. In some instances where the provided authentication information is not correct, recipient system 150 may be informed of the refusal to allow acquiring of the data.

In some embodiments, the data acquired in the initial iteration of stage 344 for an obtained dataset may include a pointer. For instance, in some cases if authentication succeeds, the acquired data may include an HTTP redirect command referencing a URL or a pointer to other data. In some of these embodiments, if the data acquired includes a pointer then method 300 may iterate back and perform any of stages 304 to 344 for the acquired data (rather than for the dataset as in the initial iteration). In these embodiments, any of stages 304 to 344 may continue to be iterated any number of times until an iteration is reached where the data acquired in stage 344 does not include a pointer. In these embodiments, once an iteration is reached where the acquired data does not include a pointer, method 300 may proceed with subsequent handling of the acquired data from the final iteration.

In some embodiments where data associated with the pointer is acquired, the acquired data may be subsequently handled by recipient system 150, for instance by acquired data handler 244. Additionally or alternatively, in some embodiments, recipient system 150, for instance placement determiner 234, may determine placement of the acquired data or a version of the acquired data. Even though the handling is illustrated in FIG. 3 as occurring before the placement, it is noted that depending on the embodiment, handling of the acquired data may occur before placement and/or after placement.

The handling of the acquired data may vary depending on the embodiment, and may include any suitable handling in any suitable order. In the illustrated embodiments, handling may include application execution, inverse transformation, adjustment and/or filtering as described below with reference to stages 346 through 360 but in some other embodiments, other type(s) of handling may additionally or alternatively be performed. Additionally or alternatively in some other embodiments, the order of performance of stages 346 through 360 may be different than the order illustrated in FIG. 3.

In some embodiments, handling of the acquired data may result in creation of a version of the acquired data. In some of these embodiments, the version of the acquired data may include at least one instruction that would not necessarily have been acceptable to every channel security module(s) 134 and/or to security module(s) 210 if the instruction(s) had been included in the dataset and/or in the acquired data, and/or the version may include data which would not necessarily have been supported by every available potential receiving system (for example not necessarily supported by receiving systems without pointer activator 230).

For simplicity of description, handling is described with reference to stages 346 through 360 as being performed on the acquired data, although in some embodiments the handling may be performed on the data resulting from one or more previous handling stages of the acquired data. One of the reasons for this simplified language is that in some cases, various embodiments may follow different sequences in performing the same handling stages.

In the illustrated embodiments in stage 346, it is determined by recipient system 150, for instance by acquired data handler 244 if an application is to be automatically executed relating to the data acquired from acquired data source 120. In some embodiments, the pointer may specify the application, for instance the application name and/or location. Additionally or alternatively, in some other embodiments the associated application may be determined based on the type of acquired data. For instance, in some of these other embodiments, a word processor application may be associated with an acquired document file, Adobe® Acrobat Reader or a similar application may be associated with an acquired pdf file, a browser may be associated with an acquired URL, a text editor may be associated with an acquired text segment, etc.

Assuming an application is to be executed (yes to stage 346), then in the illustrated embodiments, in stage 348 recipient system 150, for instance acquired data handler 244 automatically executes the application. For instance, in various of these embodiments, if the acquired data included a document file then a word processor application may be executed to open the acquired document file, if the acquired data included a pdf file then Adobe Acrobat Reader or a similar application may be executed to open the acquired pdf file, if the acquired data included a URL then a browser application may be executed to navigate to the URL, if the acquired data included a text segment then a text editor application may be executed to insert the acquired text segment in the text editor, etc. In some cases of these embodiments, the application may have been locally stored, for example in memory 206 or elsewhere in recipient system 150.

In some cases, automatic execution of an application may be advantageous to the receiving user, for instance because the receiving user may in some cases not know that application execution is desirable and/or may not know how to execute the application. In some of these cases, automatic execution of an application may be preceded by a user notification for security reasons.

In the illustrated embodiments, in stage 352, it is determined by recipient system 150, for instance acquired data handler 244 if some or all of the acquired data had been previously transformed (e.g. by data preparation system 110 and/or by acquired data source 120, etc.) and therefore inverse transformation of the acquired data is required. For example, in some implementations, transformation and inverse transformation may always be performed or never be performed, and therefore it is known a-prior whether or not inverse transformation is required. In another example, pointer activator 230 maybe provided with a separate indication from acquired data source 120 whether or not inverse transformation should be performed on the acquired data. In another example, additionally or alternatively pointer activator 230 may recognize from the acquired data whether or not inverse transformation should be performed for instance based on the format/contents of the acquired data.

If inverse transformation is required (yes to stage 352) then in the illustrated embodiments, in stage 356, recipient system 150, for instance acquired data handler 244, inverse transforms some or all of the acquired data, in accordance with an inverse transformation which typically is the inverse of a transformation performed on the acquired data (e.g. by data preparation system 110 and/or by acquired data source 120. etc). If inverse transformation is not required, then in the illustrated embodiments stage 356 is omitted.

The disclosure does not impose limitations on the type of inverse transformation performed in stage 356. The inverse transformation may be any suitable inverse transformation which typically is the inverse of a previously performed transformation (e.g. by data preparation system 110 and/or acquired data source 120, etc). In some embodiments, the inverse transformation includes at least one of decrypting, decoding, decompressing, etc. Additionally or alternatively, in some embodiments, where the acquired data was not acquired in a way which precluded filtering by channel security module(s) 134 and/or security module(s) 210, the inverse transformation may recover at least one instruction which in the recovered form would not necessarily have been acceptable to every channel security module(s) 134, and/or security module(s) 210. Additionally or alternatively, in some embodiments the inverse transformation may recover data which in the recovered form would not necessarily have been supported by every available receiving system which could potentially have acquired the data (for example not necessarily supported by receiving systems without pointer activator 230). For instance, in some of these embodiments, not all receiving systems which could potentially receive the acquired data may support non-ASCII characters if present in the acquired data, and therefore in some cases any non-ASCII characters may have been transformed (e.g. by data preparation system 110 and/or acquired data source 120, etc) so as to be present only in the transformed form in the acquired data. In this instance, the inverse transformation in stage 356 may recover the non-ASCII characters.

In the illustrated embodiments, in stage 358, filtering may be performed on the acquired data, for example by security module(s) 210 or by separate security module(s) in pointer activator 230. In embodiments with filtering, the filtering performed in stage 358 may or may not be less restrictive than filtering that security module(s) 134 performs and/or than filtering that occurred before this stage. Continuing with the example, less restrictive may in some cases mean that some data which would have been unacceptable to channel security module(s) 134 and/or before, may be considered acceptable at stage 358, the threshold for acceptability may be lower, and/or that data which includes unacceptable data may be handled less strictly. Continuing with the example, in one of these embodiments the filtering in stage 358 may include dropping certain elements such as the object element (but not dropping scripts, images, interactive fields/content, forms, pointers, and style elements) and scanning using an anti-virus scanner. Depending on the embodiment, the filtering policy may be customized per recipient system 150 or per pointer activator 230, or the filtering policy may be configured from some central location such as a server.

In some other embodiments, stage 358 may be omitted, for instance because no filtering of the acquired data is desired.

In the illustrated embodiments in stage 360 acquired data handler 244 adjusts some or all of the acquired data. The types of adjustment are not limited by embodiments of the presently disclosed subject matter but for further illustration to the reader, some examples are now presented.

For example, one type of adjustment may include converting data to a different type, such as XML data to HTML data or vice versa.

In another example, additionally or alternatively, data may be added to the acquired data by acquired data handler 244. In some cases of this example new notification(s) for the receiving user are added, for instance informing the receiving user that a pointer was automatically activated. In some cases of this example, additionally or alternatively, data added by acquired data handler 244 ensures that upon presentation of the acquired data or a version thereof to the receiving user, it will be evident that the presented acquired data or version relates to the pointer. For instance, in some of these cases acquired data handler 244 may insert a table with a frame insert visual start and/or end (e.g. text, image or a combination) markers, (e.g. using JavaScript or an Application Programming Interface API).

In some other embodiments, stage 360 may be omitted, for instance because no adjustment is desired.

In the illustrated embodiments in stage 364, recipient system 150, for instance placement determiner 234, determines where to place the acquired data or a version thereof with respect to the dataset. These embodiments assume that the obtained dataset, acquired data or version thereof does not indicate where the acquired data or version thereof should be placed. In some cases, it may be advantageous that recipient system 150 determines the placement because recipient system 150 may know information that was not necessarily available to acquired data source 120, data preparation system 110, element originating data, etc. Additionally or alternatively, in some cases it may be advantageous that recipient system 150 determines the placement because the acquired data may potentially be obtained/handled by differently configured recipient systems (for instance because the same receiving user may be associated with differently configured recipient systems, and/or because acquired data may potentially be obtained/handled by different receiving users associated with differently configured recipient systems). Additionally or alternatively, in some cases it may be advantageous that recipient system 150 determines the placement because the previous handling may cause a certain placement to be preferable.

For example, placement determiner 234 may determine that the acquired data or version thereof should be placed in the same window as the obtained dataset, either replacing the pointer or pointer transformation that was included in the dataset (and optionally also replacing other data in the dataset such as tag(s) accompanying the pointer/transformation and/or notification data), or in addition to the pointer/transformation. As another example, placement determiner 234 may determine that the acquired data or a version thereof should be placed in a different window or a different application than the obtained dataset.

In some other embodiments, stage 364 may be omitted because recipient system 150 does not determine where to place the acquired data or version thereof. For instance, in some of these embodiments, the format/contents of the acquired data or a version thereof may dictate where the acquired data or version thereof should be placed, notification data in the obtained dataset may specify where the acquired data or version thereof should be placed, or a separately obtained indication may specify where the acquired data or version thereof should be placed.

In the illustrated embodiments, in stage 368, recipient system 150, for instance placement determiner 234, arranges where the acquired data or version thereof will be placed, either based on the determined placement in stage 364 or based on an indication in the acquired data, in a version thereof, or in the obtained dataset.

In some of these embodiments assume that placement determiner 234 arranges the placement of the acquired data or version thereof to be in a separate window or application from the dataset and that processing of the obtained dataset for presentation occurred prior to stage 368. In these embodiments, a new window or application may be opened by placement determiner 234, and the acquired data or version thereof may be placed in a new window or application. For instance, the new window or application may be opened using a conventional API of an operating system, web browser, mail client, etc, or may be opened in any other way known in the art. In some cases, the pointer, pointer transformation and/or other data (e.g. tag(s) accompanying the pointer/transformation and/or notification data) in the original window may be manipulated so as to be hidden from the receiving user, but in other cases the original window is not affected by the new window or application.

In some other of these embodiments, assume that placement determiner 234 arranges the placement of the acquired data or version thereof to be in a separate window or application from the dataset and that the previous stages Of method 300 occurred prior to any processing of the obtained dataset for presentation. In these embodiments, a new window or application element may be created by placement determiner 234 which includes the acquired data or version thereof, for instance using JavaScript or an API. In some cases, the pointer, pointer transformation and/or other data (e.g. tag(s) accompanying the pointer/transformation and/or notification data) may be manipulated so as to be hidden when the dataset window will subsequently be presented to the receiving user, but in other cases the content of the dataset window is not necessarily manipulated.

In some cases with a separate window or application, cookies may be inserted by placement determiner 234 in the new window, new application, new window element, or new application element. For instance, pointer activator 230 may possess an authentication token (see above discussion of authentication information) which may later be required by the receiving user when performing an operation with a remote server. Therefore in some of these cases of these examples, an authentication cookie holding an authentication token may be inserted, so that any communicator such as for instance communicator 202, may later send the cookie to the remote server when the receiving user performs the operation.

In some other of these embodiments, assume that placement determiner 234 arranges the placement of the acquired data or version thereof to be in the same window as the obtained dataset, and that the previous stages of method 300 occurred prior to any processing of the obtained dataset for presentation. In these embodiments, the acquired data or version thereof may be integrated into the obtained dataset by placement determiner 234 in any appropriate manner. For example the acquired data or version thereof may be placed in an adapted IFrame element in order to isolate the acquired data or version thereof from any other data in the dataset, thereby precluding any clash between the acquired data/version thereof and the other data, such as for example due to the same JavaScript function, variable names, etc. Additionally or alternatively, in this example the isolation may be for security reasons so that the dataset can not access the acquired data or version thereof. It is noted that traditionally the “IFrame” element includes a source URL for the source of the data to show in the frame. However, in some cases the acquired data or version thereof may be local to recipient system 150 (for instance in memory 206) and therefore in these cases the IFrame element may be adapted from conventional use. The adaption may include, in some of these cases, creating an IFrame element with no source. Alternatively, in some other of these cases, the adaption may include creating an IFrame element with a source URL, for example using a “dummy” URL. (A dummy URL may in some instances be identifiable as being fake due to an incorporated string which indicates that the URL is a dummy.) In these cases with a source URL, the URL request may be captured and the data from the source URL, which may in some instances be an “error page”, may be removed. In some cases of this example, where the data acquired in stage 344 or version thereof included an HTTP redirect command, the data that is returned as a response to the URL request may include a “redirect” HTTP directive to acquire data from elsewhere (i.e. from the URL referenced in the redirect command), with the data acquired as a result of the redirect being subsequently considered “acquired data” in addition to or instead of the data acquired in stage 344 or version thereof. In another example, the acquired data or version thereof may not be placed in an IFrame element but may exist as a generic (e.g. DIV) element. Depending on the instance, the acquired data or version thereof may replace the pointer or pointer transformation that was included in the dataset (and optionally also replace other data in the dataset such as tag(s) accompanying the pointer/transformation and/or notification data), or the acquired data or version thereof may be integrated in the dataset in addition to the pointer or transformation. If the acquired data or version thereof replaces the pointer, transformation and/or other data, then the pointer, transformation and/or other data may in some cases be removed from the dataset. If the data is not replacing the pointer or transformation, then the pointer or transformation may in some cases co-exist in the dataset with the acquired data or version thereof, and when the dataset is subsequently presented to the receiving user, the pointer or transformation may be visible to the receiving user or may be hidden, depending on the example.

In some cases where placement determiner 234 arranges the placement of the acquired data or version thereof to be in the same window as the obtained dataset, and the previous stages of method 300 occurred prior to any processing of the obtained dataset for presentation., cookies may be inserted by placement determiner 234. For instance one or more cookies may be inserted into the IFrame or generic element, Continuing with this instance, in some examples pointer activator 230 may possess an authentication token which may later be required by the user when performing an operation with a remote server. Therefore in some of these examples, an authentication cookie holding an authentication token may be inserted in the IFrame element or generic element so that any communicator such as for instance communicator 202, may later send the cookie to the remote server when the user performs the operation.

In some other of these embodiments assume that placement determiner 234 arranges the placement of the acquired data or version thereof to be in the same window as the obtained dataset, and that processing of the obtained dataset for presentation occurred prior to stage 368. In some cases of these embodiments, placement determiner 234 may perform one or more actions when arranging the placement of the acquired data or version thereof to be in the same window which will trigger additional processing of the obtained dataset by processor/executor 208. In these cases, if additional processing were not triggered, processor/executor 208 may have assumed that the earlier processing of the dataset for presentation was sufficient.

The disclosure does not limit the actions performed in arranging the placement of the acquired data or version thereof to be in the same window which would trigger the additional processing. However for the sake of further illustration to the reader, some examples of embodiments will now be presented.

In some embodiments where triggering is desirable, if the acquired data or version thereof is to replace the pointer or pointer transformation (and optionally other data included in the dataset), the pointer or pointer transformation (and optionally other data) may be removed by placement determiner 234, so as to no longer be designated for subsequent presentation to the receiving user via input/output 204. For example, assuming that there is a document object model or similar model in memory 206 corresponding to the dataset, placement determiner 234 may find the lowest model element (in the document object model hierarchy or similar hierarchy) which contains the entire pointer or pointer transformation (and optionally other data) and may erase the contents of this element, thereby removing the pointer or pointer transformation (and optionally other data). In cases where the acquired data or version is not going to replace the pointer or pointer transformation, then the pointer or pointer transformation may not necessarily be removed.

In some embodiments where triggering is desirable, data may then be inserted by placement determiner 234.

For example, in some of these embodiments, the acquired data or version thereof may be scanned by placement determiner 234, in order to find certain or all instructions (if any) which if remaining in the acquired data or version thereof would not be automatically executed by processor/executor 208. The certain or all instructions (if any) may be removed (i.e. stripped) from the acquired data/version thereof. In these embodiments, placement determiner 234 may insert the stripped data (i.e. the acquired data/version thereof minus the removed instructions). In these embodiments, placement determiner 234 may provide the stripped instructions (if any) to processor/executor 208, thereby triggering processor/executor 208 to perform additional processing of the dataset. For instance in various cases, the acquired data/version thereof may be scanned for instructions such as script and/or style elements, may be scanned for instructions such as script, image, interactive field/content, pointer, form and/or style elements, or may be scanned for any one or more types of elements, and these instructions (if any) may be removed. In these cases and assuming that processor/executor 208 is part of a browser, the removed instructions may be added to the browser engine using the browser application programming interface API. In these cases and assuming that there is a document object model or similar model associated with the dataset in memory 206, the stripped data (i.e. the data minus the stripped instructions) may then be inserted. For instance, the stripped data may be inserted or replaced into the lowest model element in the document object model hierarchy or similar model hierarchy which contained the entire pointer or pointer transformation (and optionally other data) prior to removal (if the pointer/transformation is to be replaced), somewhere else in the document object model or similar model, etc. In some of these cases, elements included in the pointer/pointer transformation and/or in the stripped data may be provided with large arbitrary identification values so as not to conflict with any existing elements identification values in the document object model or other model. For instance a long prefix may be added to each element identifier.

Alternatively or additionally, in another example, in some of these embodiments, it is assumed that there is a document object model or similar model associated with the dataset in memory 206. In this example placement determiner 234, may insert an adapted “IFrame” element. In various cases, the adapted “IFrame” element may be inserted or replaced inside the lowest model element in the document object model hierarchy or similar model hierarchy which contained the entire pointer or pointer transformation (and optionally other data) prior to removal (if the pointer or pointer transformation is to be replaced), somewhere else in the document object model or similar model, etc. The inserting may be performed using for example JavaScript or an API. It is noted that traditionally the “IFrame” element includes a source URL for the source of the data to show in the frame. However, in these embodiments the acquired data or version thereof may in some cases be local to recipient system 150 (for instance in memory 206) and therefore in these cases the IFrame element may be adapted from conventional use. The adaption may include, in some of these cases, creating an IFrame element with no source. Alternatively, in some other of these cases, the adaption may include creating an IFrame element with a source URL, for example using a “dummy” URL. (A dummy URL may in some instances be identifiable as being fake due to an incorporated string which indicates that the URL is a dummy.) In these cases with a source URL, the URL request may be captured and the data from the source URL, which may in some instances be an “error page”, may be removed. In some embodiments of this example, where the data acquired in stage 344 or version thereof included an HTTP redirect command, the data that is returned as a response to the URL request may include a “redirect” HTTP directive to acquire data from elsewhere (i.e. from the URL referenced in the redirect command), with the data acquired as a result of the redirect being subsequently considered “acquired data” in addition to or instead of the data acquired in stage 344 or version thereof. In this example, placement determiner 234 may use JavaScript to insert the acquired data or version thereof into the adapted IFrame element. In some cases of this example, placement determiner 234 may insert JavaScript code in the adapted IFrame element to adjust the IFrame dimensions within the presentation of the dataset. Because usage of the IFrame element signals that the contents are new, the insertion of the IFrame element may trigger processor/executor 208 to perform additional processing on the dataset, namely to process the contents of the IFrame element which in these cases may include the acquired data or version thereof. Furthermore, because the contents of the IFrame element are isolated from the contents of the data in which the IFrame element was inserted, there should not be conflicts between elements in the acquired data/version thereof and any existing elements identification values in the document object model or other model, such as for example due to the same JavaScript function, variable names, etc.

Alternatively or additionally, in another example, in some of these embodiments, it is assumed that there is a document object model or similar model associated with the dataset in memory 206. In this example, placement arranger 234 may insert or replace a created element such as an “object” element inside the lowest model element in the document object model hierarchy or similar model hierarchy which contained the pointer or pointer transformation (and optionally other data) prior to removal (if the pointer or pointer transformation is to be replaced), somewhere else in the document object model or similar model, etc. The insertion may be performed using for instance JavaScript or an API. The inserted object element may be a reference, for instance, to an object. Among the attribute(s) of the object element may be the URL or personal URL of the acquired data, for instance. The insertion of an object element may trigger processor/executor 208 to perform additional processing on the dataset, namely to invoke the object and pass object information from inside the object tag to the invoked object. The invoked object may be for instance a flash object, an alternate processor (which processes the embedded instructions differently than processor/executor 208), etc. The invoked object may in some cases use the URL or personal URL to acquire data and/or may enforce various security policies and filtering on the acquired data or version thereof.

In some insertion examples, cookies may also be inserted by placement arranger 234. Referring for instance to the insertion examples described above, in some embodiments one or more cookies may be provided to processor/executor 208, one or more cookies may be inserted into the IFrame element, or one or more cookies may be passed to the invoked object, respectively. Continuing with these examples, in some cases pointer activator 230 may possess an authentication token which may later be required by the user when performing an operation with a remote server. Therefore in some of these cases of these examples, an authentication cookie holding an authentication token may be provided to processor/executor 208, inserted in the IFrame element, or passed to the invoked object, respectively so that any communicator such as for instance communicator 202, may later send the cookie to the remote server when the user performs the operation.

In some instances, some or all of the handling of the acquired data (e.g. any of stages 346 to 360) may occur after stage 364 and/or 368. In some of these instances data adjusting may occur after stage 364 and/or 368, i.e. after placement of the data has been determined and/or arranged, so that the adjusting corresponds to the placement. Additionally or alternatively, in some of these instances an associated application may be executed after stage 364 and/or 368.

In the illustrated embodiments, method 300 then ends.

In some embodiments data may be subsequently processed for presentation to the receiving user by recipient system 150, for instance by processor/executor 208. Depending on the example, processor executor 208 and user input/output 204 may or may not be located at the same location as pointer activator 230. In examples in which processor/executor 208 and user input/output 204 are at a different location than pointer activator 230, a transfer of data to processor/executor 208 may in some cases occur prior to the subsequent processing for presentation.

In some embodiments with subsequent processing, if there were any instructions in the acquired data or version thereof, the subsequent processing causes at least one instruction in the acquired data or version thereof to be executed. In some other embodiments with subsequent processing, the acquired data or version thereof may not include instructions which are executed during the subsequent processing.

Depending on the embodiment with subsequent processing, the subsequent processing may include inter-alia an (initial) processing of the dataset for presentation (if the dataset had not previously been processed for presentation), or the subsequent processing may occur after the dataset had already been previously processed for presentation.

Assume embodiments where the subsequent data processing includes an initial processing of the dataset for presentation. In these embodiments, if the window with the dataset includes the acquired data or version thereof integrated within, then during the processing processor/executor 208 may process the window with the dataset which includes the acquired data or version thereof integrated within. Otherwise, if the window including the dataset is separate from the window (or application) which includes the acquired data or version thereof, then in these embodiments during the processing processor/executor 208 may process separately the window including the dataset and the window (or application) including the acquired data or version thereof.

Assume embodiments where the subsequent processing occurs after the dataset had previously been processed for presentation, and that the placement of the acquired data or version thereof had been arranged to be in a separate window or application than the dataset. In these embodiments, during the subsequent processing, processor/executor 208 may process the window or application including the acquired data or version thereof for presentation. Optionally processor/executor 208 may also process the window which includes the dataset during the subsequent processing.

Assume embodiments where the subsequent processing occurs after the dataset had already been processed for presentation, and that the placement of the acquired data or version thereof had been arranged to be in the same window as the dataset. In these embodiments, as a result of the triggering discussed above processor/executor 208 may process the window with the dataset which includes the acquired data or version thereof integrated within, during the subsequent processing.

In one example of these embodiments, assume that the stripped instructions (if any) had been provided to processor/executor 208, and the stripped data has been inserted, for instance inserted in place of the removed pointer or pointer transformation (and optionally other data) if the pointer or pointer transformation is being replaced, inserted somewhere else in the document object model or similar model corresponding to the dataset, etc. In this example, the subsequent processing for presentation by processor/executor 208, may cause the provided stripped instructions (if any) to be executed by processor/executor 208.

In another example of these embodiments, assume that an adapted IFrame element has been inserted as described above. In this example, the subsequent processing for presentation by processor/executor 208 may include processing the IFrame element contents, causing instructions (if any) in the acquired data or version thereof to be executed by processor/executor 208.

In another example of these embodiments, assume that an object element has been inserted as described above. In this example, the subsequent processing by processor/executor 208 may include invoking the object element, which causes instructions (if any) in the acquired data or version thereof to be executed by the invoked object.

In some instances, the subsequent processing may cause the creation of a version of the acquired data. For instance, the version may vary from the acquired data or any version created by handling due to the execution of one or more included instruction(s). In some other instances, the subsequent processing may not include execution of instruction(s) nor creation of a version.

After the subsequent processing, the acquired data or version thereof may in various instances be presented to the receiving user via user input/output 204 in a separate window or application, in the same window in place of the pointer or pointer transformation (and optionally other data), or in the same window in addition to the pointer or pointer transformation, depending on the arrangement of stage 368.

In some embodiments, there may be some indication that the acquired data or version thereof which is being presented to the receiving user is related to the pointer. For example, the acquired data or version thereof may be presented in a manner which indicates that relationship to the pointer, including for instance a frame or visual markers optionally inserted by acquired data handler 244 as discussed above. Additionally or alternatively, in another example, a separate indication may be provided to the receiving user via user output 254.

In some embodiments, recipient system 150, for example a communicator such as communicator 202, may provide an indication to data preparation system 110 and/or to acquired data source 120 that data relating to the pointer was presented to the user.

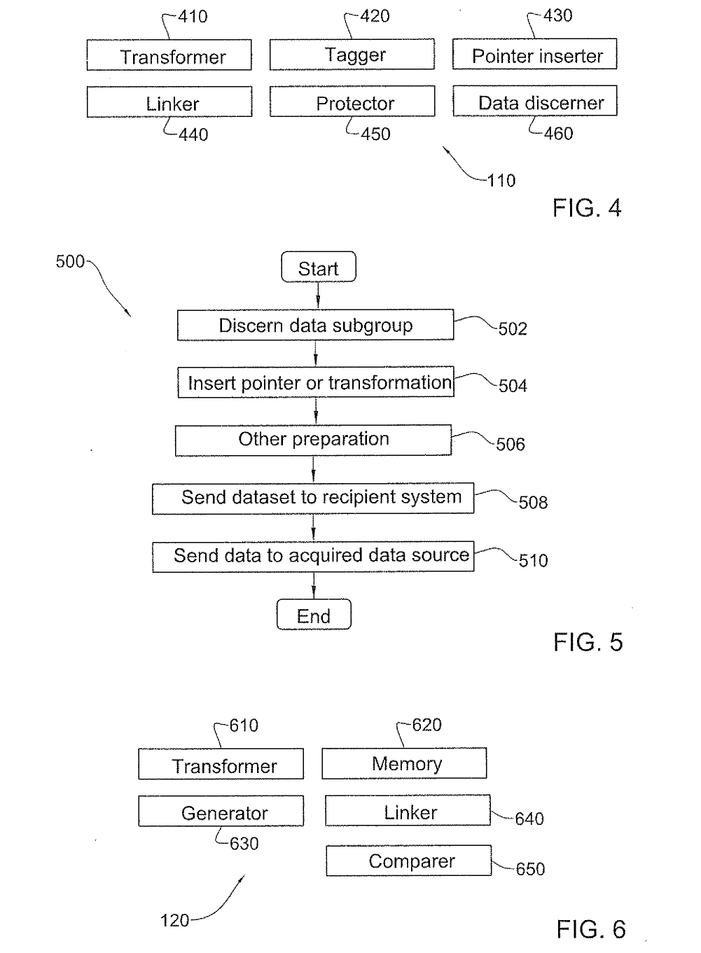

FIG. 4 is a block diagram of data preparation system 110 according to some embodiments of the presently disclosed subject matter. In the illustrated embodiments, data preparation system 110 includes a pointer inserter 430 configured to insert one or more pointers or pointer transformations in a dataset. In some embodiments, data preparation system 110 may optionally also include any of the following: a transformer 410 configured to transform, a tagger 420 configured to insert tags and/or notification data in a dataset, a protector 450 configured to protect data, a linker 440 configured to send and/or receive data and/or a data discerner 460 configured to discern a data subgroup to be replaced by a pointer or pointer transformation. Each of the modules in data preparation system 110 may be made up of any combination of software, hardware and/or firmware capable of performing the operations as defined and explained herein. Depending on the embodiment, modules in data preparation system 110 may be concentrated in one unit or separated among two or more units.

The disclosure does not limit the type of data preparation system 110 but for the sake of further illustration to the reader some examples are now provided. In some embodiments, any of the modules in data preparation system 110 may be included in any of the following: a web browser; a mail client; an instant messaging client; any other type of Internet client; a user interface; a peer to peer application; an SMS application; a messaging application; a plug in, an add-on, a toolbar or an applet for a browser, mail client, instant messaging client or any other application, a stand alone client; any other suitable element servicing one user device; a gateway; a proxy server; any other type of server; and/or any other element servicing multiple user devices; an element with any other suitable configuration, etc.

In some embodiments where automatic activation of a pointer in a dataset leads to acquirement of data, data preparation system 110 may function as a system configured to enable the later acquiring of data not included in a dataset.

In some embodiments, data preparation system 110 may comprise fewer, more, and/or different modules than those shown in FIG. 4. Additionally or alternatively in some embodiments, the functionality of data preparation system 110 described herein may be divided differently among the modules of FIG. 4. Additionally or alternatively in some embodiments, the functionality of data preparation system 110 described herein may be divided into fewer, more and/or different modules than shown in FIG. 4 and/or data preparation system 110 may include additional, less and/or different functionality than described herein.

FIG. 5 is a flowchart of a method 500 of enabling the later acquiring of data not included in a dataset, according to some embodiments of the presently disclosed subject matter. Method 500 may be performed in some embodiments by data preparation system 110. In some cases, method 500 may include fewer, more and/or different stages than illustrated in FIG. 5, the stages may be executed in a different order than shown in FIG. 5, stages that are illustrated as being executed sequentially may be executed in parallel, and/or stages that are illustrated as being executed in parallel may be executed sequentially.

Some of the embodiments described herein refer to a data group which in some cases may include a data subgroup that data preparation system 110 may replace by a pointer or pointer transformation. For example, the data group may have originated from an element at the same location or at a different location than data preparation system 110 as described above. Some of the described embodiments additionally or alternatively refer to a dataset which may be sent by data preparation system 110 to recipient system 150, which may include a pointer or pointer transformation, and which optionally may also include data from the data group which was not in the subgroup (if any) and/or other data. For simplicity of description it is assumed in the embodiments described herein that there is at most one subgroup in a data group, and/or that there is at most one pointer or pointer transformation in a dataset. However, in other embodiments there may be more than one subgroup and/or more than one pointer or transformation, and similar methods and systems to those described herein may be applied, mutatis mutandis.

In the illustrated embodiments in stage 502, data preparation system 110, for instance data discerner 460, discerns in the data group a data subgroup which is to be replaced by a pointer or pointer transformation.

In some cases, the discerning may be based on data discerner 460 recognizing that the data subgroup includes one or more instructions, one or more instructions of predefined type(s) and/or one or more instructions that may not necessarily be acceptable to every security module and/or includes data that may not necessarily be supported by every available receiving system.

In some cases, the discerning may additionally or alternatively be based on data discerner 460 determining that the data subgroup includes data which should be accessible only after authentication information has been provided.

In some cases, the discerning may additionally or alternatively be based on policy considerations. For instance, data discerner 460 may desire to replace a certain subgroup with a pointer or pointer transformation in order to increase the speed of transfer of the dataset, reduce the bandwidth required for transfer of the dataset, allow for the possibility of updating of the subgroup or a transformation thereof prior to acquisition by the receiving user, etc.

In some other embodiments, stage 502 may be omitted because any pointer or pointer transformation which may be inserted in stage 504 would not be replacing a data subgroup.

In the illustrated embodiments, in stage 504, data preparation system 110, for instance inserter 403 inserts a pointer or pointer transformation in the data subset. Depending on the embodiment, the inserted pointer or pointer transformation may or may not replace a data subgroup. In embodiments where the inserted pointer or pointer transformation replaces a data subgroup, the replaced data subgroup is the one discerned in stage 502.

As mentioned above, the disclosure does not impose limitations on the pointer which is included or whose transformation is included in the dataset. For example, in some embodiments, the pointer (or transformation thereof) may be in a form acceptable to most (or to substantially all) security module(s). Continuing with this example, in some of these embodiments, the pointer or transformation may include only plain text (e.g. no hypertext markup language HTML tags) or may not include certain HTML tags such as script tags. In some embodiments, additionally or alternatively, the pointer or transformation thereof may be in a form supported by most (or substantially all) available receiving system which could potentially be used to receive the data. As another example, in some embodiments, the pointer may additionally or alternatively be associated with a resource (e.g. data subgroup and/or other resource), may specify the location where the resource is available, and optionally may also specify the resource, the means to retrieve the resource, the method to retrieve the resource, and/or parameter(s) to retrieve the resource (such as resource ID). Continuing with the example, in some cases the pointer may specify a uniform resource locator “URL” (e.g. address of webpage) or other location indication and may also include parameters regarding the communication method or protocol to be used to retrieve the data. In some embodiments, the pointer may additionally or alternatively specify a generic reference. In some embodiments, the pointer may additionally or alternatively specify the name and/or location of an application which is to be executed. In some embodiments, the pointer may additionally or alternatively be what is termed a personal pointer in that the pointer may include an identification parameter. For instance the personal pointer may be a personal URL. In some embodiments, the pointer may additionally or alternatively specify if the pointer is to be automatically activated. In some embodiments, the pointer may additionally or alternatively specify validation requirement(s) and/or validation item(s)). In some embodiments, the pointer may additionally or alternatively specify other parameter(s) relevant and/or irrelevant to the currently disclosed subject matter.

In embodiments where a pointer transformation is inserted, data preparation system 110, for instance transformer 610, may transform a pointer using any type(s) of transformation. For instance, transformation may include in some cases encrypting data, encoding data and/or compressing data.

In the illustrated embodiments, in stage 506 other preparation task(s) may be performed by data preparation system 110. The disclosure does not impose limitations on the other preparation task(s) but for the sake of further illustration to the reader some examples are now provided.

In some examples of these embodiments of stage 506, data preparation system 110, for instance tagger 420, may insert tag(s) in the dataset such as a beginning tag before the pointer or pointer transformation and/or an end tag after the pointer or pointer transformation. In some cases, tagger 420 may additionally or alternatively insert notification data, for instance relating to action(s) that may have been performed in method 500, or relating to action(s) that may be performed when the dataset is obtained (e.g. by recipient system 150 and/or by the receiving user).

In some examples of these embodiments of stage 506, the replaced data subgroup (if any) may be transformed by data preparation system 110, for instance by transformer 610, including any type(s) of transformation. For instance, transformation may include in some cases encrypting data, encoding data and/or compressing data.

In some examples of these embodiments, data preparation system 110, for instance protector 450, may protect the dataset, the pointer (or transformation thereof) and/or the replaced data subgroup (if any) by creating validation requirement(s), validation item(s), authentication information, and/or by otherwise protecting data. For instance, protector 450 may perform any of the following: create a message authentication code, create a digital signature, create a hash, create a certificate, add a specific location (e.g. URL) for validation, create a user password, credentials, hardware token, and/or decryption key, etc for authentication, etc.

In some other embodiments, no other preparation tasks are performed and stage 506 may be omitted.

In the illustrated embodiments in stage 508, data preparation system 110, for example linker 440, sends the dataset, including at least the inserted pointer or pointer transformation, to recipient system 150 via channel 130. In some cases, indications regarding the dataset, inserted pointer, and/or pointer transformation may additionally or alternatively be separately sent.

In some other embodiments, stage 508 may be omitted, for instance if recipient system 150 instead pulls the dataset from data preparation system 110.

In the illustrated embodiments in stage 510, data preparation system 110, for example linker 440, may send data other than the dataset to a new location, for instance to acquired data source 120 or to another destination. For example the sent data may include the data subgroup or a transformation thereof. Additionally or alternatively, if authentication is required, then the sent data may include authentication information which is expected to be received in order to be able to access data or for other purposes (e.g. verification of establishing an account or service). In cases of this example where authentication information is sent, the authentication information may have been determined by the element which originated the data group and/or by data preparation system 110. Depending on the embodiment, the transfer between data preparation system 110 and acquired data source 120 or the other destination may be an internal transfer (for instance if data preparation system 110 and acquired data source 120 or other destination are in the same unit) or an external transfer via channel 130 or via a different communication channel. If an external transfer, then in some cases the data subgroup or transformation thereof and/or authentication information may be transferred in a manner which precludes filtering by any channel security module(s) for example using a cryptographic protocol such as SSL or using a communication channel without channel security module(s).

In some of these embodiments, data may be sent to more than one acquired data source and/or other destinations. For instance, the data subgroup or a transformation thereof may be sent to a particular acquired data source (optionally along with authentication information) and a pointer to the particular acquired data source and optionally other data required by the particular acquired data source and/or authentication information may be sent to a different acquired data source.

In some other embodiments, no other data is sent and stage 510 may be omitted. For instance, if no data is to be acquired when activating the pointer, or if acquired data source 120 is configured to generate the data to be acquired (e.g. copy of data subgroup or transformation thereof), then in some cases the data subgroup or transformation thereof may not need to be sent to acquired data source 120. Additionally or alternatively, if no authentication information is required to acquire data associated with the pointer or for other purposes (e.g. to verify establishing of account or service), or the authentication information may be generated by acquired data source 120 or the other destination (e.g. entity responsible for establishing account or service) then in some cases, authentication information may not need to be sent.

Refer to FIG. 6 which is a block diagram of acquired data source 120 according to some embodiments of the presently disclosed subject matter. In the illustrated embodiments, acquired data source 120 includes a linker 640 configured to receive and/or send data, and optionally also includes any of the following: a transformer 610 configured to transform data, a memory 620 configured to store data, a comparer 650 configured to compare authentication data, and/or a generator 630 configured to generate and/or modify data. Each of the modules in acquired data source 120 may be made up of any combination of software, hardware and/or firmware capable of performing the operations as defined and explained herein. Depending on the embodiment, modules in acquired data source 120 may be concentrated in one unit or separated among two or more units.

In some embodiments, acquired data source 120 may comprise fewer, more, and/or different modules than those shown in FIG. 6. Additionally or alternatively, in some embodiments, the functionality of acquired data source 120 described herein may be divided differently among the modules of FIG. 6. Additionally or alternatively, in some embodiments, the functionality of acquired data source 120 described herein may be divided into fewer, more and/or different modules than shown in FIG. 6 and/or acquired data source 120 may include additional, less, and/or different functionality than described herein. For example, in some cases, acquired data source 120 may only include memory 620 but not generator 630 or vice versa.

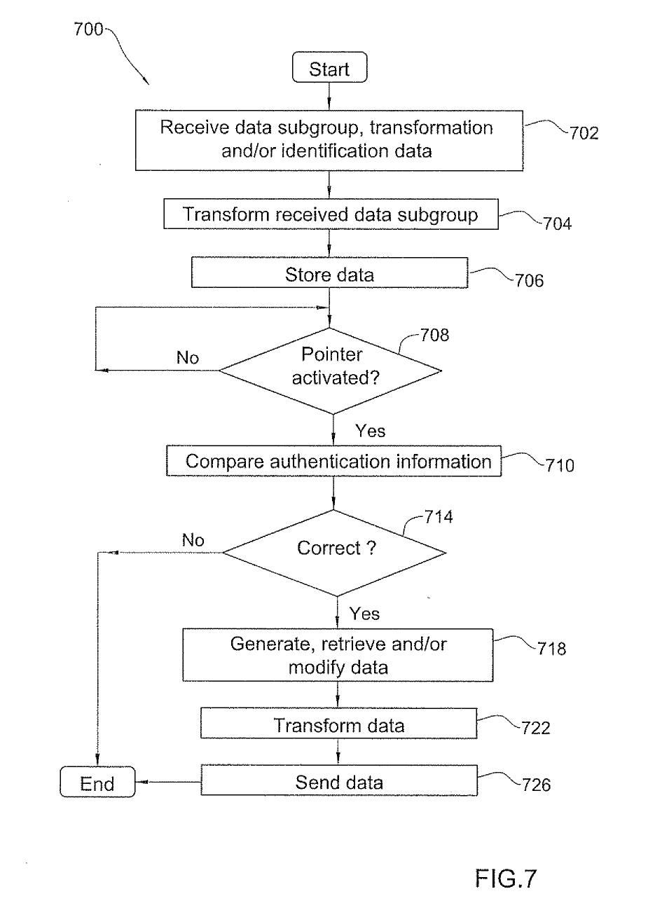

FIG. 7 is a flowchart of a method 700 of enabling acquisition of data associated with a pointer, according to some embodiments of the presently disclosed subject matter. Method 700 may be performed in some embodiments by acquired data source 120. In some cases, method 700 may include fewer, more and/or different stages than illustrated in FIG. 7, the stages may be executed in a different order than shown in FIG. 7, stages that are illustrated as being executed sequentially may be executed in parallel, and/or stages that are illustrated as being executed in parallel may be executed sequentially.

In the illustrated embodiments, in stage 702, acquired data source 120, for instance linker 640, receives data sent by data preparation system 110. For example linker 650 may receive a data subgroup or a data subgroup transformation, and/or may receive authentication information. Additionally or alternatively, linker 650 may receive a pointer to a different acquired data source, and/or data which would need to be provided to recipient system 150 for provision to the different acquired data source.

In some other embodiments, stage 702 may be omitted, for instance if acquired data source 120 generates data on the fly as will be described below, or for any other reason.

In the illustrated embodiments, in stage 704, assuming a data subgroup was received, acquired data source 120, for instance transformer 610, transforms the received data subgroup using any type(s) of transformation. For example, transformation may include in some cases encrypting data, encoding data and/or compressing data. In embodiments where data was received which would be provided to the recipient system 150 for provision to a different acquired data source, this data may in some cases be transformed.

In some other embodiments, stage 704 may be omitted. For instance stage 704 may be omitted because a transformation of the subgroup was received from data preparation system 110, because transformation of the subgroup will be performed at a later stage, or because data may be acquired by a receiving system such as recipient system 150 in a non-transformed form.

In the illustrated embodiments, in stage 706 data is stored, for instance in memory 620. For example, the received data subgroup or a transformation thereof, and optionally any received authentication information may be stored in an entry in the memory (for instance if data requires prior authentication prior to being provided to a receiving system). In another example, additionally or alternatively, a pointer to a received data subgroup or transformation thereof, a pointer to such a pointer, and/or an HTTP redirect command to a URL of a data subgroup or transformation thereof, and optionally any received authentication information may be stored in an entry in the memory (for instance if the pointer requires prior authentication prior to being provided to a receiving system). Optionally, if the stored pointer refers to a different acquired data source, any data which may need to be provided to recipient system 150 for provision to the different acquired data source may also be stored. In this example a pointer whose activation at recipient system 150 causes matching and/or retrieval of the stored data may include a unique reference to this memory entry.

In some other embodiments, stage 706 may be omitted, for instance if acquired data source 120 may generate data on the fly as described below.

In the illustrated embodiments in stage 708, it is determined by acquired data source 120, for instance by linker 640, whether or not a request for data has been received from a receiving system such as recipient system 150. If no (no to stage 708) then method 700 waits until such a request occurs. If and when there is a request (yes to stage 708), then in the illustrated embodiments method 700 continues.

For example, the activation of a pointer at recipient system 150 may function as a request for data from acquired data source 120. In some cases the activated pointer may include a unique reference to an entry in memory 620 or may include a generic reference.

In the illustrated embodiments, in stage 710, acquired data source 120, for instance comparer 650, compares authentication information received from recipient system 150 against authentication information available to acquired data source 120 which corresponds to the requested data. For example, corresponding authentication information may be stored in memory 620 of acquired data source 120, for instance in a memory location specified in the activated pointer. Additionally or alternatively, corresponding authentication information may be generated and/or modified by acquired data source 120, for instance by generator 630 (e.g. modification of information may include a modification of stored information, such as updating, whereas generation of information may not be based on any stored information).

In various embodiments where authentication information is received by acquired data source 120, for instance by linker 640, from recipient system 150, authentication information may be provided by recipient system 150 without acquired data source 120 first requesting for the authentication information, and/or authentication information may be provided by recipient system 150 after being requested to do so by acquired data source 120.

In the illustrated embodiments, in stage 714, acquired data source 120, for instance comparer 650, determines if the received authentication information matches the stored generated and/or modified authentication information corresponding to the requested data, If yes (yes to stage 714), then the receiving user and/or recipient system 150 are considered authenticated and in the illustrated embodiments method 700 continues. If not (no to stage 714), then in the illustrated embodiments method 700 ends. Alternatively, if not (no to stage 714), method 700 may return to stage 708 awaiting the next request. Optionally, acquired data source 120, for example linker 640 may inform recipient system 150 of the refusal.

In some other embodiments, stages 710 and 714 may be omitted, for instance because no authentication information is required for recipient system 150 to acquire data associated with the activated pointer.

In the illustrated embodiments, in stage 718, data is retrieved, modified and/or generated.

For instance, in some embodiments where acquired data source 120 includes memory 620, data may be retrieved from a memory entry whose location is referenced in the activated pointer.

Additionally or alternatively, in some embodiments where acquired data source 120 includes data generator 630, and the activated pointer includes a generic reference, data generator 620 may generate data on the fly. For instance, the current balance and last three transactions may be retrieved and returned to recipient system 150, optionally after being formatted for rendering on recipient system 150. Additionally or alternatively in some embodiments, data generator 620 may modify (e.g. update) retrieved data. In some cases of these embodiments, the generation or modification may vary depending on the configuration of recipient system 150, for optimal rendering by recipient system 150.

In the illustrated embodiments, in stage 722, the retrieved, generated and/or modified data may be transformed using any type(s) of transformation by acquired data source 120, for instance by transformer 610. For example, transformation may include in some cases encrypting data, encoding data and/or compressing data.

Additionally or alternatively, the retrieved, generated and/or modified data may be formatted for rendering on recipient system 150, for example using HTML.

In some other embodiments, stage 722 may be omitted. For instance stage 722 may be omitted because a transformation of the subgroup was received from data preparation system 110, because transformation of the subgroup was performed earlier by transformer 610 (e.g. at stage 704), or because data may be acquired by recipient system 150 in a non-transformed form.

Therefore depending on the embodiment, the data which will be acquired by recipient system 150 may not have undergone transformation, or may have undergone transformation at data preparation system 110 and/or at acquired data source 120. Transformation may have been performed for any reason depending on the embodiment. For instance, transformation may have been performed because the data will not necessarily be sent in a manner which precludes filtering by channel security module(s) and/or in order to ensure that (untransformed) non- ASCII characters are not included in the acquired data.

In the illustrated embodiments, in stage 726 the data to be acquired is provided to recipient system 150. For instance the data may be sent by acquired data source 120, for instance by linker 640, or may be pulled by recipient system 150. The acquired data may be the data retrieved, generated and/or modified in stage 718 or a transformation thereof (e.g. transformed in stage 722), depending on the embodiment.

In some embodiments the provision of the acquired data is performed in a way which precludes filtering by channel security module(s) 134, for instance using a cryptographic protocol such as SSL or for instance, using a communication channel other than channel 130 which does not include channel security module(s). In some of these embodiments provision in a manner which precludes filtering may be always performed while in other of these embodiments, provision in such a manner may only be performed if the acquired data has not been transformed. In some of these embodiments where the acquired data includes a pointer and/or an HTTP redirect command, provision in a manner which precludes filtering may be always performed, in other of these embodiments, provision in such a manner may only be performed if the pointer and/or HTTP redirect command has not been transformed, while in further of these embodiments where the acquired data includes a pointer and/or HTTP redirect command, provision in a manner which precludes filtering may not necessarily be performed.

In the illustrated embodiments, after stage 726 method 700 ends. Alternatively, after stage 726 method 700 may return to stage 708 and wait for the next request.

In some embodiments, pointers created by data preparation system 110 and/or acquired data source 120 for a specific receiving user may be stored in a memory entry associated with that receiving user. Storage of pointers in memory may be performed by data preparation system(s) and/or acquired data source(s) associated with a single provider or with multiple providers. If storage is shared by multiple providers then for a particular pointer, information on the relevant provider may also be saved. In these embodiments, a receiving user may therefore have a “mailbox” of pointers which were provided to that receiving user (e.g. in obtained datasets and/or in acquired data) and the receiving user may be provided with tools to view the mailbox, delete items from the mailbox, etc.

Although the form of a dataset and/or the form of a pointer, and are not limited by the disclosure, for the sake of further illustration to the reader some examples will now be given.

Some examples of a dataset include inter-alia: a message [such as an email message (e.g. web-based or desktop email client based), SMS, social network message (e.g. Facebook message, Twitter “tweet”, etc) instant messaging message, etc], a webpage, etc.

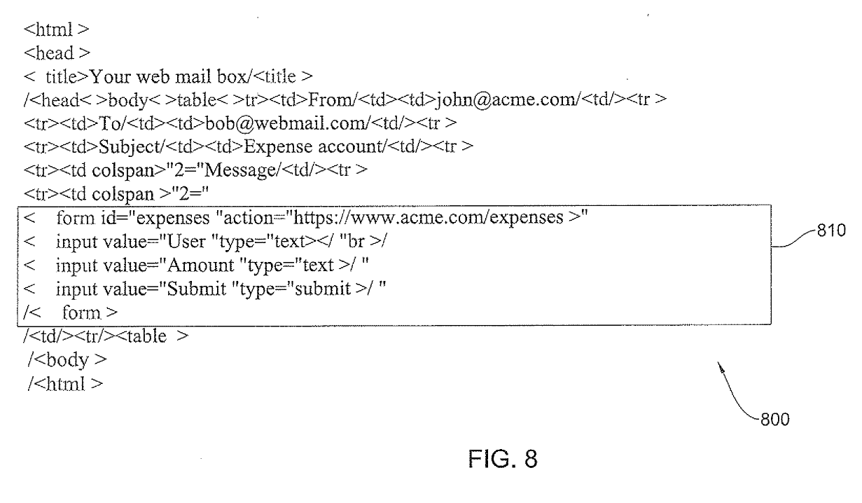

FIG. 8 illustrates an example of a data group 800 prior to insertion of a pointer by data preparation system 110, according to some embodiments of the presently disclosed subject matter. In the illustrated embodiments of this example, data group 800 is a message which includes a data subgroup 810 which will be replaced by a pointer or pointer transformation. It is noted that data subgroup 810 includes a “form” instruction which in some cases may be unacceptable to security module(s) if data group 800 were transferred as shown. For instance, in some cases, a security module may remove the “form” instruction, may delete all of data group 800, may classify data group 800 as containing a potentially dangerous instruction, etc.

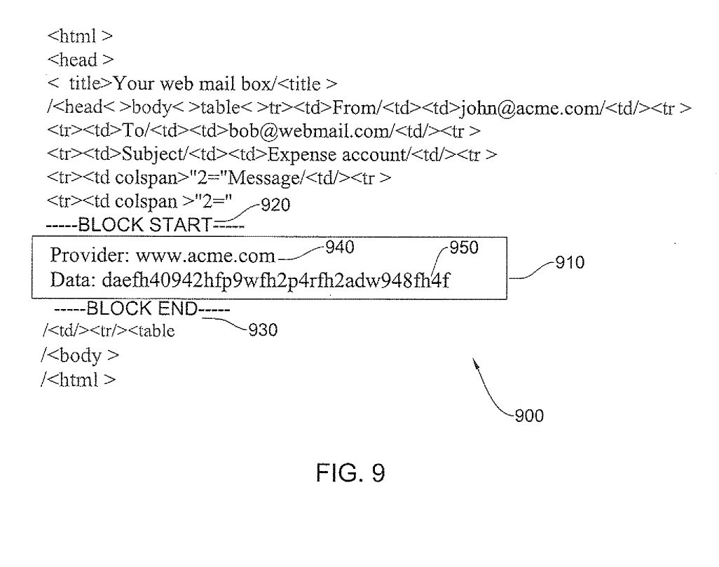

FIG. 9 illustrates an example of a dataset 900 which includes a pointer 910, according to some embodiments of the presently disclosed subject matter. It is noted that dataset 900 is the same message as data group 800 except that pointer 910 has been substituted for data subgroup 810, and beginning tag 920 and ending tag 930 have been added before and after pointer 910 respectively. In the illustrated embodiments of this example, pointer 910 includes a specification of the location of the data to be acquired (e.g. provider 940) and a specification of the data to be acquired (e.g. data 950).

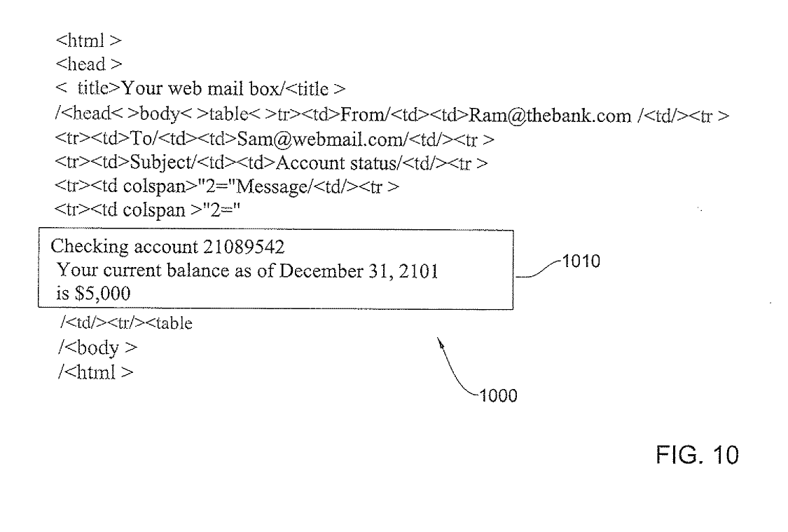

FIG. 10 illustrates another example of a data group 1000 prior to insertion of a pointer by data preparation system 110, according to some embodiments of the presently disclosed subject matter. In the illustrated embodiments of this example, data group 1000 is a message which includes a data subgroup 1010 which will be replaced by a pointer or pointer transformation. It is noted that data subgroup 1010 includes data which should only be accessible after authenticating the receiving user and/or recipient system.

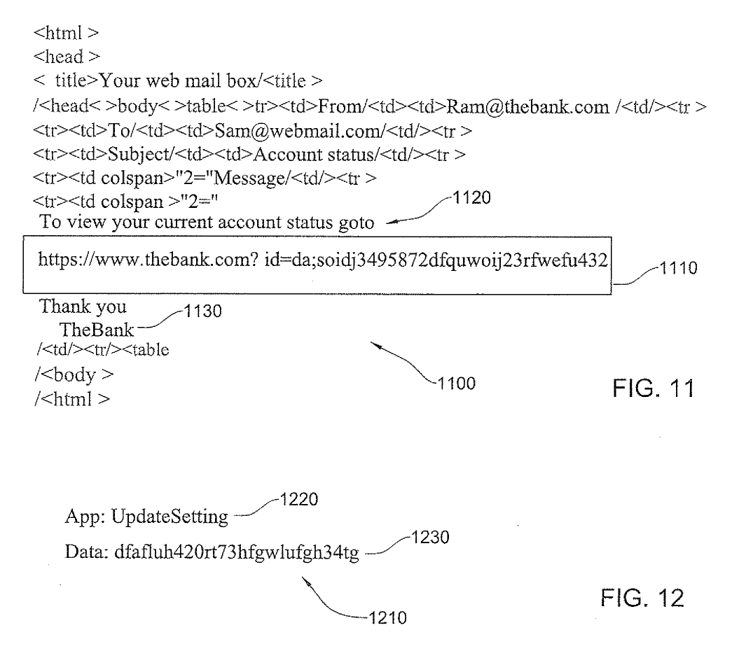

FIG. 11 illustrates another example of a dataset 1100 which includes a pointer 1110, according to some embodiments of the presently disclosed subject matter. It is noted that dataset 1100 is the same message as data group 1000 except that pointer 1110 has been substituted for data subgroup 1010, and notifications 1120 and 1130 have been added before and after pointer 1110 respectively. In the illustrated embodiments of this example, pointer 1110 is a personal pointer since the pointer specifies an identification parameter (e.g. “id=da;soidj3495872dfquwoij23rfwefu432”). In some cases, retrieving the data associated with the specified pointer will require user and/or system authentication as per authentication information.

FIG. 12 illustrates another example of a pointer 1210, according to some embodiments of the presently disclosed subject matter. In the illustrated embodiments of this example, pointer 1210 includes a specification 1220 of an application to be executed, and a specification 1230 of the data to be provided to the application. The location of the application may be implicit or explicit. In some embodiment, this pointer or a transformation of this pointer may be inserted in a dataset by data preparation system 110.

It will also be understood that in some embodiments a system or part of a system according to the presently disclosed subject matter may be a suitably programmed machine. Likewise, some embodiments of the presently disclosed subject matter contemplate a computer program being readable by a machine for executing a method of the presently disclosed subject matter. Some embodiments of the presently disclosed subject matter further contemplate a machine-readable memory tangibly embodying a program of instructions executable by the machine for executing a method of the presently disclosed subject matter.

While the presently disclosed subject matter has been shown and described with respect to particular embodiments, it is not thus limited. Numerous modifications, changes and improvements within the scope of the presently disclosed subject matter will now occur to the reader.

1. A method of acquiring data which was not included in an obtained dataset, comprising:
recognizing that a dataset which was obtained over a communication channel includes a pointer or a transformation thereof;
activating automatically said pointer; and
providing authentication information so as to acquire data associated with said pointer.

2. The method of claim 1, wherein said pointer is a personal pointer.

3. The method of claim 1, further comprising: retrieving said authentication information from memory, wherein said retrieved authentication information is automatically provided during said automatic activation.

4. The method of claim 1, further comprising:
determining that said pointer is a candidate for automatic activation based on at least one of the following: a characteristic of said pointer, a characteristic of said dataset, a specification in said pointer, or a specification in said dataset.

5. The method of claim 1, further comprising:
inverse transforming said transformation of said pointer included in said dataset prior to automatically activating said pointer.

6. The method of claim 1, further comprising:
determining placement of said acquired data or a version thereof with respect to said dataset.

7. The method of claim 1, further comprising: arranging placement of said acquired data or a version thereof to be in the same window as said dataset.

8. The method of claim 7, wherein placement of said acquired data or a version thereof is arranged so as to replace said pointer or transformation.

9. The method of claim 1, further comprising: arranging placement of said acquired data or a version thereof to be in a different window or application than said dataset.

10. The method of claim 1, further comprising:
handling said acquired data, wherein said handing includes automatically executing an application.

11. The method of claim 1, further comprising:
handling said acquired data, wherein said handling includes at least one selected from a group comprising adjusting, filtering, or inverse transforming.

12. The method of claim 1, wherein said obtained dataset is in a form which is acceptable to most security modules in said channel, and wherein said acquired data or a version thereof includes at least one instruction which would not necessarily have been acceptable to every security module in said channel.

13. A method of enabling the later acquiring of data which will not be included in a dataset, comprising:
inserting in a dataset a pointer or a transformation thereof;
wherein after said dataset is obtained via a communication channel, said pointer is automatically activated and authentication information is provided so as to acquire data associated with said pointer.

14. The method of claim 13, wherein said pointer is a personal pointer, and specifies an identification parameter.

15. The method of claim 13, wherein said pointer specifies an application to be automatically executed in handling said acquired data.

16. A method of acquiring data which was not included in an obtained dataset, comprising:
recognizing that a dataset which was obtained over a communication channel includes a pointer or a transformation thereof; and
automatically activating said pointer so as to acquire data associated with said pointer;
wherein said acquired data or a version thereof includes at least one instruction which would not necessarily have been acceptable to every security module in said channel.

17. The method of claim 16, further comprising:
providing authentication information.

18. The method of claim 16, further comprising:
determining that said pointer is a candidate for automatic activation based on at least one of the following: a characteristic of said pointer, a characteristic of said dataset, a specification in said pointer, or a specification in said dataset.

19. The method of claim 16, further comprising:
inverse transforming said transformation of said pointer included in said dataset prior to automatically activating said pointer.

20. The method of claim 16, further comprising:
determining placement of said acquired data or a version thereof with respect to a said dataset.

21. The method of claim 16, further comprising: arranging placement of said acquired data or a version thereof to be in the same window as said dataset.

22. The method of claim 21, wherein placement of said acquired data or a version thereof is arranged so as to replace said pointer or transformation.

23. The method of claim 16, further comprising: arranging placement of said acquired data or a version thereof to be in a different window or application than said dataset.

24. The method of claim 16, further comprising:
handling said acquired data, wherein said handling includes automatically executing an application associated with said acquired data.

25. The method of claim 16, further comprising: processing said acquired data, wherein said processing includes at least one selected from a group comprising adjusting, filtering, or inverse transforming.

26. A method of enabling the later acquiring of data not included in a dataset, comprising:
inserting in a dataset a pointer or a transformation thereof;
wherein after said dataset is obtained via a communication channel, said pointer is automatically activated so as to acquire data associated with said pointer which includes, or after further handling would include, at least one instruction which would not necessarily have been acceptable to every security module in said channel.

27. The method of claim 26, wherein said pointer specifies an application to be automatically executed in handling said acquired data.

28. A method of automatic pointer activation, comprising:
recognizing that a dataset which was obtained over a communication channel includes a pointer or a transformation thereof;
determining whether or not said pointer is a candidate for automatic activation, based on whether or not there is a match between a provider referenced by said pointer and any provider listed as being associated with automatic activation; and
if there is a match, activating automatically said pointer.

29. The method of claim 28, further comprising:
if there is not a match, then prompting a user on whether or not to allow future automatic activation for said provider;
if said user desires future automatic activation, then listing said provider as being associated with automatic activation.

30. A system for acquiring data which was not included in an obtained dataset, comprising:
a pointer recognizer operable to recognize that a dataset which was obtained over a communication channel includes a pointer or a transformation thereof; and
an automatic handler operable to activate automatically said pointer, and to provide authentication information so as to acquire data associated with said pointer.

31. The system of claim 30, further comprising:
an identity manager and a memory, wherein said identity manager is operable to retrieve said authentication information from said memory, and wherein said retrieved authentication information is automatically provided during automatic activation of said pointer.

32. The system of claim 30, further comprising:
a checker operable to determine that said pointer is a candidate for automatic activation based on at least one of the following: a characteristic of said pointer, a characteristic of said dataset, a specification in said pointer, or a specification in said dataset.

33. The system of claim 30, further comprising: an acquired data handler operable to automatically execute an application in handling said acquired data.

34. The system of claim 30, further comprising: a placement determiner operable to determine placement of said acquired data or a version thereof with respect to said dataset.

35. A system for enabling the later acquiring of data not included in a dataset, comprising:
a pointer inserter operable to insert in a dataset a pointer or a transformation thereof;
wherein after said dataset is obtained via a communication channel, said pointer is activated automatically and authentication information is provided so as to acquire data associated with said pointer.

36. The system of claim 35, further comprising: a data discerner operable to recognize data which should be accessible only after authentication and to remove such data so that said dataset does not include such data.

37. A system for acquiring data which was not included in an obtained dataset, comprising:
a pointer recognizer operable to recognize that a dataset which was obtained over a communication channel includes a pointer or a transformation thereof; and
an automatic handler operable to automatically activate said pointer so as to acquire data associated with said pointer;
wherein said acquired data or a version thereof includes at least one instruction which would not necessarily have been acceptable to every security module in said channel.

38. The system of claim 37, further comprising: a checker operable to determine that said pointer is a candidate for automatic activation based on at least one of the following: a characteristic of said pointer, a characteristic of said dataset, a specification in said pointer, or a specification in said dataset.

39. The system of claim 37, further comprising: an acquired data handler operable to automatically execute an application in handling said data.

40. The system of claim 37, further comprising: a placement determiner operable to determine placement of said acquired data or a version thereof with respect to said dataset.

41. A system for enabling the later acquiring of data not included in a dataset, comprising:
a pointer inserter operable to insert in a dataset a pointer or a transformation thereof;
wherein after said dataset is obtained via a communication channel, said pointer is automatically activated so as to acquire data associated with said pointer which includes, or after further handling would include, at least one instruction which would not necessarily have been acceptable to every security module in said channel.

42. The system of claim 41, further comprising: a data discerner operable to recognize at least one instruction which is not necessarily acceptable to every security module in said channel and to remove said at least one instruction so that said dataset excludes said at least one instruction.

43. A system for automatic pointer activation, comprising:
a pointer recognizer operable to recognize that a dataset which was obtained over a communication channel includes a pointer or a transformation thereof;
a checker operable to determine whether or not said pointer is a candidate for automatic activation, based on whether or not there is a match between a provider referenced by said pointer and any provider listed as being associated with automatic activation; and
an automatic handler operable, if there is a match, to activate automatically said pointer.

44. A computer program product comprising a computer useable medium having computer readable program code embodied therein for acquiring data which was not included in an obtained dataset, the computer program product comprising:
computer readable program code for causing the computer to recognize that a dataset which was obtained over a communication channel includes a pointer or a transformation thereof;
computer readable program code for causing the computer to activate automatically said pointer; and
computer readable program code for causing the computer to provide authentication information so as to acquire data associated with said pointer.

45. A computer program product comprising a computer useable medium having computer readable program code embodied therein for enabling the later acquiring of data which will not be included in a dataset, the computer program product comprising:
computer readable program code for causing the computer to insert in a dataset a pointer or a transformation thereof;
wherein after said dataset is obtained via a communication channel, said pointer is automatically activated and authentication information is provided so as to acquire data associated with said pointer.

46. A computer program product comprising a computer useable medium having computer readable program code embodied therein for acquiring data which was not included in an obtained dataset, the computer program product comprising:
computer readable program code for causing the computer to recognize that a dataset which was obtained over a communication channel includes a pointer or a transformation thereof; and
computer readable program code for causing the computer to automatically activate said pointer so as to acquire data associated with said pointer;
wherein said acquired data or a version thereof includes at least one instruction which would not necessarily have been acceptable to every security module in said channel.

47. A computer program product comprising a computer useable medium having computer readable program code embodied therein for enabling the later acquiring of data not included in a dataset, the computer program product comprising:
computer readable program code for causing the computer to insert in a dataset a pointer or a transformation thereof;
wherein after said dataset is obtained via a communication channel, said pointer is automatically activated so as to acquire data associated with said pointer which includes, or after further handling would include, at least one instruction which would not necessarily have been acceptable to every security module in said channel.

48. A computer program product comprising a computer useable medium having computer readable program code embodied therein for automatic pointer activation, the computer program product comprising:
computer readable program code for causing the computer to recognize that a dataset which was obtained over a communication channel includes a pointer or a transformation thereof;
computer readable program code for causing the computer to determine whether or not said pointer is a candidate for automatic activation, based on whether or not there is a match between a provider referenced by said pointer and any provider listed as being associated with automatic activation; and
computer readable program code for causing the computer, if there is a match, to activate automatically said pointer.

49. The method of claim 1, wherein said acquired data includes a pointer.

50. The method of claim 1, wherein said acquired data includes an HTTP redirect command.
